(19) United States
(12) Patent Application Publication
(10) Pub. No.: US 2015/0231854 A1
(43) Pub. Date: Aug. 20, 2015

(54) LAYERED STRUCTURE AND METHOD FOR MANUFACTURING SAME, AND ARTICLE

(71) Applicant: MITSUBISHI RAYON CO., LTD., Chiyoda-ku (JP)

(72) Inventors: Yusuke Nakai, Otake-shi (JP); Go Otani, Otake-shi (JP); Tetsuya Jigami, Otake-shi (JP)

(73) Assignee: Mitsubishi Rayon Co., Ltd., Chiyoda-ku (JP)

(21) Appl. No.: 14/432,824

(22) PCT Filed: Oct. 11, 2013
(86) PCT No.: PCT/JP2013/077776

§ 371 Date: Apr. 1, 2015

(30) Foreign Application Priority Data
Oct. 22, 2012 (JP) 2012-232808

(51) Int. Cl. B32B 3/30; B32B 38/00

(52) U.S. Cl. CPC B32B 3/30; B32B 38/0008; B32B 2250/02; B32B 2255/00; B32B 2307/40

(57) ABSTRACT

One aspect of the present invention provides a laminate structure having two or more layers laminated, wherein at least two layers have a fine relief structure on surfaces thereof, a concave portion and a convex portion of a fine relief structure of an arbitrary layer are differently disposed from a concave portion and a convex portion of a fine relief structure of another at least one layer, and an interface is not release treated. Another aspect of the present invention provides a laminate structure having two or more layers laminated, wherein an outermost layer is a layer which does not have a fine relief structure on a surface thereof, and at least one layer other than the outermost layer has a fine relief structure on a surface thereof.

### TECHNICAL FIELD

The present invention relates to a laminate structure and a method for manufacturing the same, and an article.

This application is based upon and claims the benefit of priority of the prior Japanese Patent Application No. 2012-232808, filed on Oct. 22, 2012, the entire contents of which are incorporated herein by reference.

### BACKGROUND ART

An article having a fine relief structure with a cycle equal to or less than the wavelength of visible light on the surface is known to exhibit the antireflection performance by a continuous change in refractive index of the fine relief structure. In addition, the fine relief structure is also known to exert the ultra-water-repellent performance by the lotus effect.

As a method for manufacturing an article having a fine relief structure on the surface, for example, the following methods have been proposed.

(i) A method in which a fine relief structure is transferred to a thermoplastic resin using a mold having the reverse structure of the fine relief structure on the surface when injection molding or press molding the thermoplastic resin.

(ii) A method in which an active energy ray-curable resin composition is filled between a mold having the reverse structure of a fine relief structure on the surface and a substrate and cured by irradiating with an active energy ray, and then the mold is released therefrom to transfer the fine relief structure onto the cured product.

Alternatively, a method in which an active energy ray-curable resin composition is filled between the mold described above and the substrate, the mold is released therefrom to transfer the fine relief structure onto the active energy ray-curable resin composition, and the active energy ray-curable resin composition is then cured by irradiating with an active energy ray.

Between these, the method of (ii) has received attention from the viewpoint of favorable transferability of the fine relief structure, a high degree of freedom in the composition of the article surface, in addition, the possibility of continuous production in a case in which the mold is a belt or a roll, and excellent productivity.

As the active energy ray-curable resin composition used in the method of (ii), for example, the following compositions have been proposed.

A photocurable resin composition containing an acrylate oligomer such as a urethane acrylate, an acrylic resin having a radical polymerizable functional group, a mold releasing agent, and a photopolymerization initiator (Patent Document 1).

An ultraviolet curable resin composition containing a polyfunctional(meth)acrylate such as trimethylolpropane tri(meth)acrylate, a photopolymerization initiator, and a leveling agent such as polyether-modified silicone oil (Patent Document 2).

However, the laminate body formed by laminating two or more layers is usually required to be excellent in adhesion between the layers.

However, the adhesion of the layer (cured layer) composed of the cured product of an active energy ray-curable resin composition to the substrate is not necessarily sufficient. In addition, it is difficult to impart all of the optical performance, the mechanical properties (excoriation resistance, pencil hardness and the like) and the like at a practical level in a case in which the fine relief structure is formed on the surface of the cured layer.

As a method to enhance the adhesion of the substrate to the cured layer, for example, a method is known in which a layer (for example, an adhesion promoting layer or a primer layer) for securing the adhesion with the cured layer is provided on the surface of the substrate or the surface of the substrate is roughened (for example, hair line processed or blasted).

In addition, as a method to achieve both of the antireflection performance and the mechanical properties (excoriation resistance and pencil hardness), a method (Patent Document 3) is known in which an intermediate layer is provided between the cured layer of the active energy curable resin composition having a fine relief structure transferred thereto and the substrate.

In addition, as a method which can sufficiently lower the reflectance even in a case in which the refractive index of the substrate is high, a method (Patent Document 4) is known in which a layer having a refractive index between those of the cured layer and the substrate is laminated between the cured layer of the active energy curable resin composition having a fine relief structure transferred thereto and the substrate.

### CITATION LIST

### Patent Documents

Patent Document 1: JP 4156415 B1

Patent Document 2: JP 2000-71290 A

Patent Document 3: JP 2011-856 A

Patent Document 4: JP 2009-31764 A

### DISCLOSURE OF THE INVENTION

### Problem to be Solved by the Invention

However, it is necessary to provide a process such as coating, drying and aging in a case in which a layer for securing adhesion with the cured layer is provided on the surface of the substrate, and thus there is a problem that the processing cost increases.

In addition, there is a problem that it is difficult to detect the foreign matters or defects on the substrate by the optical inspection since the haze of the substrate is increased by the roughening in addition to the problem that the processing cost increases in the case of conducting the roughening treatment of the surface of the substrate. Moreover, there is a problem that the active energy curable resin composition cannot sufficiently follow the rough surface of the substrate and thus the gap defect is likely to occur between the cured layer and the substrate.

In addition, the adhesion of the intermediate layer to the cured layer is likely to be insufficient in the case of providing an intermediate layer between the substrate and the cured layer as described in Patent Documents 3 and 4. It is difficult to enhance the adhesion between the layers of the intermediate layer and the cured layer having a fine relief structure on the surface particularly in a case in which the intermediate layer is also a layer composed of a cured product of an active energy ray-curable resin composition.

The invention has been made in view of the above circumstances, and an object of the invention is to provide a laminate structure exhibiting high adhesion between the layers and excellent mechanical properties, a method that can easily manufacture a laminate structure exhibiting high adhesion between the layers and excellent mechanical properties at low cost and an article excellent in mechanical properties.

### Means for Solving Problem

The invention has the following features.

<1> A laminate structure formed by laminating two or more layers, in which at least two layers have a fine relief structure on surfaces thereof, a concave portion and a convex portion of a fine relief structure of an arbitrary layer are differently disposed from a concave portion and a convex portion of a fine relief structure of another at least one layer, and an interface is not release treated.
<2> The laminate structure according to <1>, in which an average interval between concave portions or convex portions of a fine relief structure of an arbitrary layer is different from an average interval between concave portions or convex portions of a fine relief structure of another at least one layer.
<3> The laminate structure according to <1> or <2>, in which at least an outermost layer has the fine relief structure on a surface thereof.
<4> The laminate structure according to <3>, in which an average interval between concave portions or convex portions of a fine relief structure of an outermost layer is greater than an average interval between concave portions or convex portions of a fine relief structure of another at least one layer.
<5> A laminate structure formed by laminating two or more layers, in which an outermost layer is a layer which does not have a fine relief structure on a surface thereof and at least one layer other than the outermost layer has a fine relief structure on a surface thereof.
<6> The laminate structure according to any one of <1>, <2>, and <5>, in which an outermost layer is a coating layer which does not have a fine relief structure on a surface thereof.
<7> The laminate structure according to any one of <1> to <6>, in which an elastic recovery rate of an outermost layer is 70% or more.
<8> The laminate structure according to any one of <1> to <7>, in which an elastic modulus of an outermost layer is 80 MPa or more.
<9> The laminate structure according to any one of <1> to <8>, in which the layer having a fine relief structure on a surface thereof is a layer including a cured product of an active energy ray-curable resin composition.
<10> The laminate structure according to <9>, in which the active energy ray-curable resin composition contains a (meth)acrylate.
<11> The laminate structure according to any one of <1> to <10>, in which the number of notches that are peeled off when 100 squares of grid-shaped notches are formed at an interval of 2.0 mm and a pressure sensitive adhesive tape is pasted to theses notches and then peeled off therefrom is less than 50 squares among the 100 squares in the cross-cut tape peeling test in conformity with JIS K 5600-5-6: 1999 (ISO 2409: 1992).
<12> An article including the laminate structure according to any one of <1> to <11> on a surface thereof.
<13> A method for manufacturing the laminate structure according to any one of <1> to <11>, in which

the fine relief structure is formed by a transfer method using a mold.

<14> A method for manufacturing the laminate structure according to any one of <1> to <4>, the method including the following processes (1-1) and (1-2):

(1-1) a process of supplying an active energy ray-curable resin composition for an intermediate layer on a substrate, transferring a fine relief structure using a mold having a fine relief structure on a surface thereof, subsequently curing the active energy ray-curable resin composition for an intermediate layer to which the fine relief structure is transferred by irradiating with an active energy ray to form an intermediate layer, and then peeling off the intermediate layer from the mold; and

(1-2) a process of supplying an active energy ray-curable resin composition for an outermost layer on a surface of the intermediate layer obtained after repeating the process (1-1) one or more times, transferring a fine relief structure using a mold having a fine relief structure on a surface thereof, subsequently curing the active energy ray-curable resin composition for an outermost layer to which the fine relief structure is transferred by irradiating with an active energy ray to form an outermost layer, and then peeling off the outermost layer from the mold.

<15> A method for manufacturing the laminate structure according to any one of <1> to <4>, the method including the following processes (2-1) and (2-2):

(2-1) a process of supplying an active energy ray-curable resin composition for an outermost layer on a surface of a mold having a fine relief structure on the surface and transferring the fine relief structure of the mold; and

(2-2) a process of disposing a substrate on which an intermediate layer having a fine relief structure on a surface thereof is laminated on the active energy ray-curable resin composition for an outermost layer on the mold such that an intermediate layer side is in contact therewith, subsequently curing the active energy ray-curable resin composition for an outermost layer to which the fine relief structure is transferred by irradiating with an active energy ray to form an outermost layer, and then peeling off the outermost layer from the mold.

<16> A method for manufacturing the laminate structure according to any one of <1> to <4>, the method including the following processes (3-1) and (3-2):

(3-1) a process of supplying an active energy ray-curable resin composition for an outermost layer on a surface of a mold having a fine relief structure on the surface, transferring the fine relief structure of the mold, and subsequently semi-curing the active energy ray-curable resin composition for an outermost layer to which the fine relief structure is transferred by irradiating with an active energy ray; and

(3-2) a process of disposing a substrate on which an intermediate layer having a fine relief structure on a surface thereof is laminated on the semi-cured active energy ray-curable resin composition for an outermost layer on the mold such that an intermediate layer side is in contact therewith, subsequently curing the active energy ray-curable resin composition for an outermost layer by irradiating with an active energy ray to form an outermost layer, and then peeling off the outermost layer from the mold.

<17> A method for manufacturing the laminate structure according to <5>, the method including the following processes (4-1) and (4-2):

(4-1) a process of supplying an active energy ray-curable resin composition for an intermediate layer on a substrate, transferring a fine relief structure using a mold having a fine relief structure on a surface thereof, subsequently curing the active energy ray-curable resin composition for an intermediate layer to which the fine relief structure is transferred by irradiating with an active energy ray to form an intermediate layer, and then peeling off the intermediate layer from the mold; and

(4-2) a process of forming an outermost layer on a surface of the intermediate layer obtained after repeating the process (4-1) one or more times.

<18> A method for manufacturing the laminate structure according to any one of <1> to <4>, the method including the following process (5-1):

(5-1) a process of supplying an active energy ray-curable resin composition for an outermost layer on a surface of a substrate having a fine relief structure on the surface, transferring a fine relief structure using a mold having a fine relief structure on a surface thereof, subsequently curing the active energy ray-curable resin composition for an outermost layer to which the fine relief structure is transferred by irradiating with an active energy ray to form an outermost layer, and then peeling off the outermost layer from the mold.

<19> The method for manufacturing the laminate structure according to <18>, in which an intermediate layer is formed on a surface of a substrate before supplying an active energy ray-curable resin composition for an outermost layer on the surface of the substrate having a fine relief structure on the surface.
<20> The method for manufacturing the laminate structure according to <19>, in which a fine relief structure is formed on a surface of the intermediate layer by a transfer method using a mold.
<21> A method for manufacturing the laminate structure according to any one of <1> to <4>, the method including the following processes (6-1) and (6-2):

(6-1) a process of supplying an active energy ray-curable resin composition for an outermost layer on a surface of a mold having a fine relief structure on the surface and transferring the fine relief structure of the mold; and

(6-2) a process of disposing a substrate having a fine relief structure on a surface thereof on the active energy ray-curable resin composition for an outermost layer on the mold such that a fine relief structure side is in contact therewith, subsequently curing the active energy ray-curable resin composition for an outermost layer to which the fine relief structure is transferred by irradiating with an active energy ray to form an outermost layer, and then peeling off the outermost layer from the mold.

<22> The method for manufacturing the laminate structure according to <21>, in which an intermediate layer is laminated on a surface of a substrate having a fine relief structure on the surface.
<23> The method for manufacturing the laminate structure according to <22>, in which the intermediate layer has a fine relief structure on a surface thereof.
<24> A method for manufacturing the laminate structure according to any one of <1> to <4>, the method including the following processes (7-1) and (7-2):

(7-1) a process of supplying an active energy ray-curable resin composition for an outermost layer on a surface of a mold having a fine relief structure on the surface, transferring the fine relief structure of the mold, and subsequently semi-curing the active energy ray-curable resin composition for an outermost layer to which the fine relief structure is transferred by irradiating with an active energy ray; and

(7-2) a process of disposing a substrate having a fine relief structure on a surface thereof on the semi-cured active energy ray-curable resin composition for an outermost layer on the mold such that a fine relief structure side is in contact therewith, subsequently curing the semi-cured active energy ray-curable resin composition for an outermost layer by irradiating with an active energy ray to form an outermost layer, and then peeling off the outermost layer from the mold.

<25> The method for manufacturing the laminate structure according to <24>, in which an intermediate layer is laminated on a surface of a substrate having a fine relief structure on the surface.
<26> The method for manufacturing the laminate structure according to <25>, in which the intermediate layer has a fine relief structure on a surface thereof.
<27> A method for manufacturing the laminate structure according to <5>, the method including the following process (8-1):

(8-1) a process of forming an outermost layer on a surface of a substrate having a fine relief structure on the surface.

<28> The method for manufacturing the laminate structure according to <27>, in which an intermediate layer is formed on a surface of a substrate before forming an outermost layer on the surface of the substrate having a fine relief structure on the surface.
<29> The method for manufacturing the laminate structure according to <28>, in which a fine relief structure is formed on a surface of the intermediate layer by a transfer method using a mold.

### Effect of the Invention

The laminate structure of the invention exhibits high adhesion between the layers and excellent mechanical properties. The laminate structure is also excellent in optical properties particularly when the outermost layer is a layer which has a fine relief structure on the surface.

According to the method for manufacturing a laminate structure of the invention, it is possible to easily manufacture a laminate structure exhibiting high adhesion between the layers and excellent mechanical properties at low cost.

The article of the invention is excellent in mechanical properties.

### BRIEF DESCRIPTION OF DRAWINGS

FIG. 1 is a cross-sectional view illustrating an example of a laminate structure of the invention;

FIG. 2 is a cross-sectional view illustrating a manufacturing process of a mold having an anodized alumina on the surface;

FIG. 3 is a configuration diagram illustrating an example of an apparatus for manufacturing a laminate structure;

FIG. 4 is a cross-sectional view illustrating another example of a laminate structure of the invention;

FIG. 5 is a cross-sectional view illustrating still another example of a laminate structure of the invention;

FIG. 6 is a cross-sectional view illustrating still another example of a laminate structure of the invention;

FIG. 7 is a cross-sectional view illustrating still another example of a laminate structure of the invention;

FIG. 8 is a cross-sectional view illustrating still another example of a laminate structure of the invention; and

FIG. 9 is a cross-sectional view illustrating still another example of a laminate structure of the invention.

### MODE(S) FOR CARRYING OUT THE INVENTION

Hereinafter, the invention will be described in detail.

Meanwhile, in the present specification, the uppermost layer of the laminate structure is referred to as the “outermost layer”, the lowermost layer is referred to as the “substrate” or “base layer”, and the layer which is disposed between the outermost layer and the substrate is referred to as the “intermediate layer”.

In addition, in the present specification, the “surface of layer” includes the interface of two adjacent layers as well.

Moreover, in the present specification, the “active energy ray” means visible light, ultraviolet light, an electron beam, plasma, heat rays (infrared rays and the like) and the like.

Furthermore, in the present specification, the “(meth)acrylate” is a general term for an acrylate and a methacrylate, the “(meth)acrylic acid” is a general term for acrylic acid and methacrylic acid, the “(meth)acrylonitrile” is a general term for acrylonitrile and methacrylonitrile, and the “(meth)acrylamide” is a general term for acrylamide and methacrylamide.

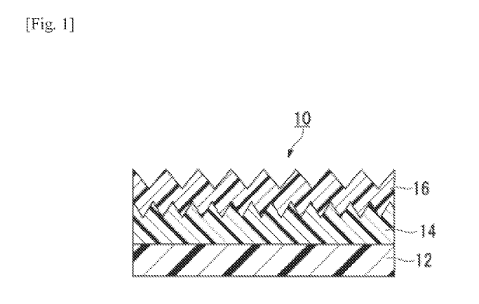

In FIGS. 1 and 4 to 9, the contraction scale is different for each layer in order to adjust each layer to a recognizable size on the drawing.

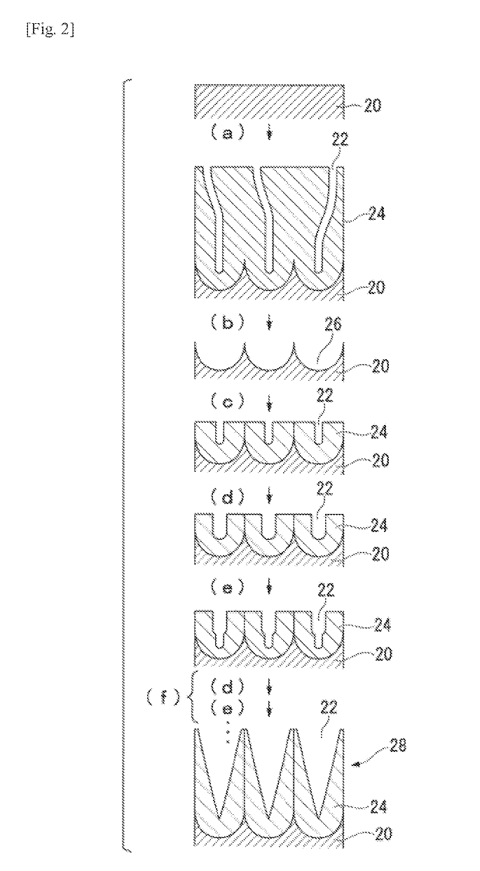

In addition, in FIGS. 2 to 9, the same components as FIG. 1 are denoted by the same reference numerals and the description thereof will be omitted in some cases.

“Laminate Structure”

<<First Aspect>>

The laminate structure according to the first aspect of the invention is constituted by laminating two or more layers and has a fine relief structure on the surfaces of at least two layers. In addition, the concave portion and convex portion of the fine relief structure of an arbitrary layer are differently disposed from a concave portion and a convex portion of the fine relief structure of another at least one layer. Hereinafter, this state of disposition is also referred to as the “different disposition”. Moreover, the laminate structure of the first aspect is characterized in that the interface is not release treated.

FIG. 1 is a cross-sectional view illustrating an example of the laminate structure according to the first aspect.

A laminate structure 10 of this example is constituted by sequentially laminating an intermediate layer 14 and an outermost layer 16 on a substrate 12, and the intermediate layer 14 and the outermost layer 16 have a fine relief structure on the surfaces.

As described above, the outermost layer is the uppermost layer of the laminate structure and the substrate is the lowermost layer of the laminate structure. In each layer constituting the laminate structure, the surface facing the uppermost layer side is the “upper surface” and the surface facing the lowermost layer side is the “lower surface”. In the invention, the upper surface of the layer is referred to as the “surface of the layer” and the lower surface of the layer is referred to as the “back surface of the layer”.

Accordingly, for example, in the laminate structure 10 illustrated in FIG. 1, the “surface of the outermost layer is the upper surface of the outermost layer 16, that is, the surface on the side that is not in contact with the intermediate layer 14, and the “back surface of the outermost layer is the lower surface of the outermost layer 16, that is, the surface on the side that is in contact with the intermediate layer 14 of the outermost layer 16. In addition, the “surface of the intermediate layer” is the upper surface of the intermediate layer 14, that is, the surface on the side that is in contact with the outermost layer 16 of the intermediate layer 14, and the “back surface of the intermediate layer” is the lower surface of the intermediate layer 14, that is, the surface on the side that is in contact with the substrate 12 of the intermediate layer 14. Moreover, the “surface of substrate” is the upper surface of the substrate 12, that is, the surface on the side that is in contact with the intermediate layer 14 of the substrate 12, and the “back surface of the substrate” is the lower surface of the substrate 12, that is, the surface on the side that is not in contact with the intermediate layer 14 of the substrate 12.

The surface of the outermost layer 16 corresponds to the surface (uppermost surface) of the laminate structure 10, and the back surface of the substrate 12 corresponds to the back surface (lowermost surface) of the laminate structure. In addition, the back surface of the outermost layer 16 and the surface of the intermediate layer 14 correspond to the interface between the outermost layer 16 and the intermediate layer 14, the back surface of the intermediate layer 14 and the surface of the substrate 12 correspond to the interface between the intermediate layer 14 and the substrate 12.

The concave portion and convex portion of the fine relief structure of the outermost layer 16 are differently disposed from the concave portion and convex portion of the fine relief structure of the intermediate layer 14.

Here, the term “differently disposed” means that the relief shape of the fine relief structure of an arbitrary layer (for example, outermost layer) does not overlap the shape of the fine relief structure of another at least one layer (for example, intermediate layer) when the laminate structure is moved parallel to the thickness direction thereof in one or more cut surfaces formed by cutting the laminate structure in the laminating direction (vertical direction) a plurality of times. Incidentally, it is not necessarily required that all of the relief shape of the fine relief structure of an arbitrary layer are in a state not to overlap the shape of the fine relief structure of another at least one layer, and some of them may overlap each other. In addition, the term “shapes do not overlap” means that the aspect ratio of the convex portion of the fine relief structure of an arbitrary layer is different from the aspect ratio of the convex portion of the fine relief structure of another at least one layer (for example, see FIGS. 1, 4 to 6 and 8) and that the fine relief structures of an arbitrary layer and another at least one layer are positioned to be mismatched with each other (for example, see FIG. 7).

Each of the interfaces of the laminate structure 10, that is, the interface between the substrate 12 and the intermediate layer 14 and the interface between the intermediate layer 14 and outermost layer 16 is not release treated. An arbitrary layer is hardly peeled off although intentional peeling is attempted and the adhesion between the layers is improved as such a configuration is adopted.

Here, the phrase “interface is not release treated” means that the surface of the substrate 12, the back surface and surface of the intermediate layer, and the back surface of the outermost layer 16 are not release treated. In addition, the “release treatment” is to form a release layer on the surface of the substrate 12, the back surface and surface of the intermediate layer, and the back surface of the outermost layer 16, for example, by coating a mold releasing agent exemplified in the description of the mold to be described below.

The shape of the concave portion and convex portion of the fine relief structure are not particularly limited, but the so-called moth-eye structure or the reverse structure thereof is preferable in which a plurality of protrusions (convex portions) in a substantially conical shape, a pyramid shape or the like are lined up. Particularly in a case in which the fine relief of the outermost layer 16 is a moth-eye structure having an average interval between the adjacent convex portions of equal to or shorter than the wavelength (400 nm) of visible light, it is effective as an antireflection means since the refractive index continuously increases from the refractive index of air to the refractive index of the material. Meanwhile, in a case in which the fine relief structure of the intermediate layer 14 is a moth-eye structure, it is effective to decrease the reflectance and to suppress the interference fringe since the reflection at the interface can be suppressed although the refractive indexes of the adjacent layers are different from each other.

The average interval between the adjacent convex portions of the fine relief structure (hereinafter, sometimes referred to as the “pitch of convex portion”) is preferably equal to or less than the wavelength of visible light, that is, 400 nm or less, more preferably 300 nm or less, and even more preferably 250 nm or less. The reflectance and the wavelength dependence of the reflectance are low when the pitch of the convex portion is 400 nm or less. The pitch of the convex portion is preferably 25 nm or more and more preferably 80 nm or more from the viewpoint of easy formation of the convex portion structure.

Meanwhile, the average interval between the adjacent convex portions is the value determined by measuring the interval between the adjacent convex portions (distance from the center of a convex portion to the center of an adjacent convex portion) at 50 points using an electron microscope and averaging these values.

It is preferable that the average interval between the concave portions or convex portions of the fine relief structure of an arbitrary layer is different from the average interval between the concave portions or convex portions of the fine relief structure of another at least one layer. It is easy to adjust the adhesion between the layers and the like by adopting such a configuration.

In addition, it is preferable that the average interval between the concave portions or convex portions of the fine relief structure of the outermost layer 16 is greater than the average interval between the concave portions or convex portions of the fine relief structure of another at least one layer (the intermediate layer 14 in the case of FIG. 1) in a case in which the outermost layer 16 has a fine relief structure on the surface as illustrated in FIG. 1. The adhesion between the layers is further enhanced, and excoriation resistance and antifouling properties of the surface of the outermost layer 16 (that is, the surface of the laminate structure 10) are improved by adopting such a configuration.

The average height of the convex portions of the fine relief structure is preferably 100 nm or more and more preferably 130 nm or more. The reflectance and the wavelength dependence of the reflectance are low when the average height of the convex portions is 100 nm or more. In addition, the adhesion between the layers can be secured. The average height of the convex portions is preferably 400 nm or less and more preferably 300 nm or less from the viewpoint of easy formation of the convex portion structure.

Meanwhile, the average height of the convex portions is the value determined by measuring the distance between the topmost part of the convex portion and the bottommost part of the concave portion present between the convex portions at 50 points when observing by the electron microscope and averaging these values.

Furthermore, the aspect ratio of the convex portion (average height of convex portions/average interval between the adjacent convex portions) is preferably from 0.8 to 5, more preferably from 1.2 to 4, and even more preferably from 1.5 to 3. The reflectance is sufficiently low when the aspect ratio of the convex portion is 0.8 or more. The excoriation resistance of the convex portion is favorable when the aspect ratio of the convex portion is 5 or less.

The elastic recovery rate of the outermost layer 16 is preferably 70% or more, more preferably 80% or more, and particularly preferably 85% or more. It is easy for the outermost layer 16 to regain its original state even if an external force is applied thereto in the transverse direction when the elastic recovery rate of the outermost layer 16 is 70% or more, and thus the scratch is hardly formed and the excoriation resistance is further improved as a result. The convex portion is hardly folded or shaved even if an external force is applied to the fine relief structure in the transverse direction particularly in a case in which the outermost layer 16 has a fine relief structure on the surface, and thus the excoriation resistance is further improved. In addition, the plastic deformation of the outermost layer 16 hardly occurs and the hollow hardly remains as the indentation when the elastic recovery rate of the outermost layer 16 is 70% or more, and thus it is possible to maintain a higher pencil hardness.

In addition, the elastic modulus of the outermost layer 16 is preferably 80 MPa or more and more preferably from 120 to 2000 MPa. It is easy for the outermost layer 16 to regain its original state even if an external force is applied thereto when the elastic modulus of the outermost layer 16 is 80 MPa or more, and thus the excoriation resistance is further improved. The convex portion is hardly cut or broken and the outermost layer 16 can easily regain its original state even if an external force is applied to the fine relief structure so as to deform the fine relief structure particularly in a case in which the outermost layer 16 has a fine relief structure on the surface.

The elastic recovery rate and the elastic modulus of the outermost layer 16 are determined by measuring the elastic recovery rate and the elastic modulus of the cured product of the material for the outermost layer 16 (for example, a resin composition for an outermost layer to be described below) by a micro-hardness tester.

Specifically, first, a test piece is fabricated by forming a cured product of the material for the outermost layer 16 on a substrate such as a glass plate. The physical properties of the cured product of the test piece are measured by the evaluation program of the [pushing (100 mN/10 seconds)]→[creeping (100 mN and 10 seconds)]→[removing of load (100 mN/10 seconds)] using the Vickers indenter and a micro-hardness tester. The elastic modulus and elastic recovery rate of the cured product are calculated from the measurement results thus obtained by the analysis software (for example, “WIN-HCU” developed by Fischer Instruments K.K.), and the values thus determined are adopted as the elastic recovery rate and elastic modulus of the outermost layer 16.

Meanwhile, the elastic recovery rate and elastic modulus of the outermost layer can also be determined by measuring the surface on the outermost layer side of the laminate structure at a depth within one tenth of the film thickness of each layer using a micro-hardness tester.

The difference between the refractive index of the substrate 12 and the refractive index of the intermediate layer 14, and the difference between the refractive index of the outermost layer 16 and the refractive index of the intermediate layer 14 are preferably 0.2 or less, more preferably 0.1 or less, and even more preferably 0.05 or less, respectively. It is possible to effectively suppress the reflection at the interfaces between the respective layers when the differences in refractive index are 0.2 or less, respectively.

The substrate 12 which is the lowermost layer of the laminate structure is preferably a molded body that transmits light. This is because the active energy ray is irradiated from the substrate side in the case of forming a fine relief structure using a mold that hardly transmits light although the detail will be described below.

Examples of such a material for the substrate 12 may include an acrylic resin (polymethyl methacrylate and the like), a polycarbonate, a styrene (co)polymer, a methyl methacrylate-styrene copolymer, cellulose diacetate, cellulose triacetate, cellulose acetate butyrate, a polyester (polyethylene terephthalate and the like), a polyamide, a polyimide, a polyether sulfone, a polysulfone, a polyolefin (polyethylene, polypropylene and the like), polymethylpentene, polyvinyl chloride, polyvinyl acetal, a polyether ketone, a polyurethane and glass. One kind of these materials may be used singly, or two or more kinds may be concurrently used.

The substrate 12 may be an injection molded body, an extrusion molded body or a cast molded body. The shape of the substrate 12 can be appropriately selected and may be a sheet shape or a film shape.

In addition, the surface of substrate 12 may be subjected to a coating treatment, a corona treatment and the like for the improvement of adhesion, antistatic properties, excoriation resistance, weather resistance and the like.

Meanwhile, examples of the material for the intermediate layer 14 may include an active energy ray-curable resin composition, a thermoplastic resin and an inorganic material, but it is preferable that the intermediate layer 14 is a layer composed of a cured product of an active energy ray-curable resin composition from the viewpoint of easy formation of the fine relief structure.

In addition, it is preferable that the outermost layer 16 is also a layer composed of a cured product of an active energy ray-curable resin composition from the viewpoint of easy formation of the fine relief structure.

Hereinafter, the active energy ray-curable resin composition will be described in detail. Meanwhile, the active energy ray-curable resin composition for an intermediate layer is referred to as the “resin composition for an intermediate layer” and the active energy ray-curable resin composition for an outermost layer is also referred to as the “resin composition for an outermost layer”.

<Active Energy Ray-Curable Resin Composition>

The active energy my-curable resin composition (hereinafter, simply referred to as the “resin composition” in some cases) is a resin composition of which the polymerization reaction proceeds by irradiating with an active energy ray and thus which is cured.

The resin composition appropriately contains, for example, a monomer, an oligomer, and a reactive polymer which have a radically polymerizable bond and/or cationically polymerizable bond in the molecule as the polymerizable component. In addition, the resin composition usually contains a polymerization initiator for curing.

(Polymerizable Component)

Examples of the monomer having a radically polymerizable bond in the molecule may include a monofunctional monomer such as a (meth)acrylate derivative(methyl(meth)acrylate, ethyl(meth)acrylate, propyl(meth)acrylate, n-butyl(meth)acrylate, i-butyl(meth)acrylate, s-butyl(meth)acrylate, t-butyl(meth)acrylate, 2-ethylhexyl(meth)acrylate, lauryl(meth)acrylate, alkyl(meth)acrylate, tridecyl(meth)acrylate, stearyl(meth)acrylate, cyclohexyl(meth)acrylate, benzyl(meth)acrylate, phenoxyethyl(meth)acrylate, isobornyl(meth)acrylate, glycidyl(meth)acrylate, tetrahydrofurfuryl(meth)acrylate, allyl(meth)acrylate, 2-hydroxyethyl(meth)acrylate, hydroxypropyl(meth)acrylate, 2-methoxyethyl(meth)acrylate, 2-ethoxyethyl(meth)acrylate and the like),(meth)acrylic acid, (meth)acrylonitrile, a styrene derivative (styrene, α-methyl styrene and the like), a (meth)acrylamide derivative ((meth)acrylamide, N-dimethyl(meth)acrylamide, N-diethyl(meth)acrylamide, dimethylaminopropyl(meth)acrylamide and the like); a difunctional monomer such as ethylene glycol di(meth)acrylate, tripropylene glycol di(meth)acrylate, isocyanuric acid ethylene oxide-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxy phenyl)propane, 2,2-bis(4-(meth)acryloxyethoxyphenyl) propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethylol tricyclodecane di(meth)acrylate, bisphenol A-ethylene oxide adduct di(meth)acrylate, bisphenol A-propylene oxide adduct di(meth)acrylate, hydroxypivalic acid neopentyl glycol di(meth)acrylate, divinyl benzene and methylene bisacrylamide; a trifunctional monomer such as pentaerythritol tri(meth)acrylate, trimethylolpropane tri(meth)acrylate, trimethylolpropane ethylene oxide-modified tri(meth)acrylate, trimethylolpropane propylene oxide modified triacrylate, trimethylolpropane ethylene oxide-modified triacrylate and isocyanuric acid ethylene oxide-modified tri(meth)acrylate; and a polyfunctional monomer such as a condensation reaction mixture of succinic acid/trimethylolethane/acrylic acid, dipentaerythritol hexa(meth)acrylate, dipentaerythritol penta(meth)acrylate, ditrimethylolpropane tetraacrylate and tetramethylolmethane tetra(meth)acrylate and an ethylene oxide adduct and a propylene oxide adduct of these polyfunctional monomers; and a di- or higher functional urethane acrylate, a di- or higher functional polyester acrylate and the like. One kind of these may be used singly or two or more kinds thereof may be concurrently used. Among these, a (meth)acrylate is preferable from the viewpoint of easily obtaining the desired elastic recovery rate and elastic modulus.

Examples of the oligomer and the reactive polymer which have a radically polymerizable bond in the molecule may include an unsaturated polyester (a condensate of an unsaturated dicarboxylic acid with a polyhydric alcohol), a polyester(meth)acrylate, a polyether(meth)acrylate, a polyol(meth)acrylate, an epoxy(meth)acrylate, a urethane(meth)acrylate, a cationic polymerization type epoxy compound, and a homopolymer or copolymer of the monomer having a radically polymerizable bond in a side chain described above.

The monomer, the oligomer and the reactive polymer which have a cationically polymerizable bond in the molecule may be a compound having a cationically polymerizable functional group (a cationically polymerizable compound) and may be any of a monomer, an oligomer and a prepolymer.

Examples of the cationically polymerizable functional group may include a cyclic ether group (an epoxy group, an oxetanyl group and the like), a vinyl ether group and a carbonate group (O—CO—O group) as a highly practical functional group.

Examples of the cationically polymerizable compound may include a cyclic ether compound (an epoxy compound, an oxetane compound and the like), a vinyl ether compound and a carbonate-based compound (a cyclic carbonate compound, a dithiocarbonate compound and the like).

Specific examples of the monomer having a cationically polymerizable bond in the molecule may include a monomer having an epoxy group, an oxetanyl group, an oxazolyl group, a vinyloxy group and the like, and among these, a monomer having an epoxy group is particularly preferable. Specific examples of the oligomer and the reactive polymer which have a cationically polymerizable bond may include a cationic polymerization type epoxy compound.

(Polymerization Initiator)

Examples of the polymerization initiator may include those known in the art.

Examples of the photopolymerization initiator may include a radical polymerization initiator and a cationic polymerization initiator in the case of curing the resin composition by the photoreaction.

The radical polymerization initiator may be those which are known in the art and generate an acid by the irradiation with an active energy ray, and examples thereof may include an acetophenone-based photopolymerization initiator, a benzoin-based photopolymerization initiator, a benzophenone-based photopolymerization initiator, a thioxanthone-based photopolymerization initiator and an acylphosphine oxide-based photopolymerization initiator. One kind of these radical polymerization initiators may be used singly or two or more kinds thereof may be concurrently used.

Examples of the acetophenone-based photopolymerization initiator may include acetophenone, p-(tert-butyl)-1′,1′,1′-trichloroacetophenone, chloroacetophenone, 2′,2′-diethoxyacetophenone, hydroxyacetophenone, 2,2-dimethoxy-2′-phenylacetophenone, 2-amino-acetophenone and dialkylaminoacetophenone.

Examples of the benzoin-based photopolymerization initiator may include benzyl, benzoin, benzoin methyl ether, benzoin ethyl ether, benzoin isopropyl ether, benzoin isobutyl ether, 1-hydroxy cyclohexyl phenyl ketone, 2-hydroxy-2-methyl-1-phenyl-2-methyl-1-one, 1-(4-isopropyl-phenyl)-2-hydroxy-2-methylpropan-1-one and benzyl dimethyl ketal.

Examples of the benzophenone-based photopolymerization initiator may include benzophenone, benzoyl benzoate, methyl benzoyl benzoate, methyl-o-benzoyl benzoate, 4-phenyl benzophenone, hydroxy benzophenone, hydroxypropyl benzophenone, acryl benzophenone and 4,4′-bis(dimethylamino)benzophenone.

Examples of the thioxanthone-based photopolymerization initiator may include thioxanthone, 2-chlorothioxanthone, 2-methylthioxanthone, diethylthioxanthone and dimethylthioxanthone.

Examples of the acyl phosphine oxide-based photopolymerization initiator may include 2,4,6-trimethylbenzoyldiphenylphosphine oxide, benzoyldicthoxyphosphine oxide and bis(2,4,6-trimethylbenzoyl)phenylphosphine oxide.

Examples of other radical polymerization initiators may include α-acyl oxime ester, benzyl-(o-ethoxycarbonyl)-α-monooxime, glyoxy ester, 3-ketocoumarin, 2-ethylanthraquinone, camphorquinone, tetramethylthiuram sulfide, azobisisobutyronitrile, benzoyl peroxide, dialkyl peroxide and tert-butyl peroxypivalate.

The cationic polymerization initiator may be those which are known in the art and generate an acid by the irradiation with an active energy ray, and examples thereof may include a sulfonium salt, an iodonium salt and a phosphonium salt. One kind of these cationic polymerization initiators may be used singly or two or more kinds thereof may be concurrently used.

Examples of the sulfonium salt may include triphenylsulfonium hexafluorophosphate, triphenylsulfonium hexafluoroantimonate, bis(4-(diphenylsulfonio)-phenyl)sulfide-bis(hexafluorophosphate), bis(4-(diphenylsulfonio)-phenyl)sulfide-bis(hexafluoroantimonate), 4-di(p-tolyl)sulfonio-4′-tert-butylphenylcarbonyl-diphenylsulfide hexafluoroantimonate, 7-di(p-tolyl)sulfonio-2-isopropylthioxanthone hexafluorophosphate and 7-di(p-tolyl)sulfonio-2-isopropylthioxanthone hexafluoroantimonate.

Examples of the iodonium salt may include diphenyliodonium hexafluorophosphate, diphenyliodonium hexafluoroantimonate and bis(dodecylphenyl)iodonium tetrakis(pentafluorophenyl)borate.

Examples of the phosphonium salt may include tetrafluorophosphonium hexafluorophosphate and tetrafluorophosphonium hexafluoroantimonate.

Examples of the thermal polymerization initiator may include an organic peroxide(methyl ethyl ketone peroxide, benzoyl peroxide, dicumyl peroxide, tert-butyl hydroperoxide, cumene hydroperoxide, tert-butyl peroxyoctoate, tert-butyl peroxybenzoate, lauroyl peroxide and the like), an azo compound (azobisisobutyronitrile and the like), and a redox polymerization initiator obtained by combining the organic peroxide described above with an amine(N,N-dimethylaniline, N,N-dimethyl-p-toluidine and the like) in the case of cuing the resin composition by the thermal reaction.

One kind of these thermal polymerization initiators may be used singly or two or more kinds thereof may be concurrently used.

The content of the polymerization initiator is preferably from 0.1 to 10 parts by mass with respect to 100 parts by mass of the polymerizable component. The polymerization easily proceeds when the content of the polymerization initiator is 0.1 parts by mass or more. The resulting cured product is less likely to be colored or the mechanical strength is less likely to decrease when the content of the polymerization initiator is 10 parts by mass or less.

(Other Components)

The resin composition may contain a nonreactive polymer.

Examples of the nonreactive polymer may include an acrylic resin, a styrene resin, a polyurethane resin, a cellulose resin, a polyvinyl butyral resin, a polyester resin and a thermoplastic elastomer.

In addition, the resin composition may contain a known additive such as a surfactant, a mold releasing agent, a lubricant, a plasticizer, an antistatic agent, a light stabilizer, an antioxidant, a flame retardant, flame retardant auxiliary, a polymerization inhibitor, a filler, a silane coupling agent, a coloring agent, a reinforcing agent, an inorganic filler, inorganic or organic fine particles, an impact modifier, a small amount of solvent other than those described above if necessary.

(Physical Properties)

It is preferable that the viscosity of the resin composition is not too high from the viewpoint that the resin composition easily flows into the fine relief structure of the mold surface although the detail will be described below. Specifically, the viscosity of the resin composition measured using a rotary Brookfield type viscometer is preferably 10000 mPa·s or less, more preferably 5000 mPa·s or less, and even more preferably 2000 mPa·s or less at 25° C.

However, there is no particular problem as log as it is possible to lower the viscosity of the resin composition by raising the temperature previously upon contact with the mold even in a case in which the viscosity is more than 10000 mPa·s. In this case, the viscosity of the resin composition measured using a rotary Brookfield type viscometer is preferably 5000 mPa·s or less and more preferably 2000 mPa·s or less at 70° C.

The lower limit of the viscosity of the resin composition is not particularly limited, but it is preferable that the viscosity is 10 mPa·s or more since the laminate structure can be efficiently manufactured without wetting and spreading.

<Method for Manufacturing Laminate Structure>

The method for forming the fine relief structures of the intermediate layer 14 and the outermost layer 16 is not particularly limited, and it is preferable to form the fine relief structures by a transfer method using a mold, specifically, by bringing the resin composition described above into contact with a mold having the reverse structure of a fine relief structure on the surface and curing.

According to the transfer method, it is possible to freely design the shape of the fine relief structure of each layer. Moreover, it is possible to easily manufacture a laminate structure in which the concave portions or convex portions of the fine relief structure of an arbitrary layer are differently disposed from the concave portions and convex portions of the fine relief structure of another at least one layer.

Hereinafter, an example of the mold used in the transfer method will be described.

(Mold)

The mold has a reverse structure of a fine relief structure on the surface.

Examples of the material for mold may include a metal (including those having an oxide film formed on the surfaces), quartz, glass, a resin and a ceramic.

Examples of the shape of the mold may include a roll shape, a circular tube shape, a flat plate shape and a sheet shape.

Examples of the method for fabricating the mold may include the following method (I-1) and method (I-2). Among them, the method (I-1) is preferable from the viewpoint that it is possible to increase the area and the fabrication is simple.

(I-1) A method to form a reverse structure of a fine relief structure by a method to form an anodized alumina having a plurality of pores (concave portions) on the surface of an aluminum substrate.

(I-2) A method to form a reverse structure of a fine relief structure on the surface of a mold substrate by an electron beam lithography, a laser beam interferometry and the like.

As the method (I−1), a method including the following processes (a) to (f) is preferable.

(a) A process of forming an oxide film on the surface of an aluminum substrate by anodizing the aluminum substrate in an electrolytic solution under a constant voltage.

(b) A process of forming a pore generating point of anodization on the surface of the aluminum substrate by removing a part or all of the oxide film.

(c) A process of forming an oxide film having a pore at the pore generating point by anodizing the aluminum substrate again in the electrolytic solution after the process (b).

(d) A process of expanding the size of the pore after the process (c).

(e) A process of anodizing again in the electrolytic solution after the process (d).

(f) A process of obtaining a mold in which an anodized alumina having a plurality of pores is formed on the surface of an aluminum substrate by repeating the process (d) and the process (e).

Process (A):

As illustrated in FIG. 2, an oxide film 24 having a pore 22 is formed by anodizing an aluminum substrate 20.

Examples of the shape of the aluminum substrate may include a roll shape, a circular tube shape, a flat plate shape and a sheet shape.

It is preferable that the aluminum substrate is subjected to a degreasing treatment in advance since the oil used when processing into a predetermined shape is attached thereto in some cases. In addition, it is preferable that the aluminum substrate is polished in order to smooth the surface state.

The purity of aluminum is preferably 99% or higher, more preferably 99.5% or higher and even more preferably 99.8% or higher. There is a case in which a relief structure having a size enough to scatter visible light by segregation of impurities is formed at the time of anodizing the aluminum substrate or the regularity of the pores obtained by anodization decreases when the purity of aluminum is low.

Examples of the electrolytic solution may include sulfuric acid, oxalic acid and phosphoric acid.

The concentration of oxalic acid is preferably 0.8 M or less in the case of using oxalic acid as the electrolytic solution. It is possible to prevent an increase in current value and to suppress the roughening of the surface of the oxide film when the concentration of oxalic acid is 0.8 M or less.

In addition, it is possible to obtain an anodized alumina having pores which have a cycle of from 100 nm to 200 nm and high regularity when the formation voltage is from 30 to 100 V. The regularity tends to decrease when the formation voltage is higher or lower than this range. The temperature of the electrolytic solution is preferably 60° C. or lower and more preferably 450 or lower. It is possible to prevent the occurrence of a phenomenon the so-called “scorch” and to suppress the breakage of pores and the disturbance of the regularity of pores caused by melting of the surface when the temperature of the electrolytic solution is 60° C. or lower.

The concentration of sulfuric acid is preferably 0.7 M or less in the case of using sulfuric acid as the electrolytic solution. It is possible to prevent an increase in current value and to maintain a constant voltage when the concentration of sulfuric acid is 0.7 M or less.

In addition, it is possible to obtain an anodized alumina having pores which have a cycle of 63 nm and high regularity when the formation voltage is from 25 to 30 V. The regularity tends to decrease when the formation voltage is higher or lower than this range. The temperature of the electrolytic solution is preferably 30° C. or lower and more preferably 200 or lower. It is possible to prevent the occurrence of a phenomenon the so-called “scorch” and to suppress the breakage of pores and the disturbance of the regularity of pores caused by melting of the surface when the temperature of the electrolytic solution is 30° C. or lower.

Process (b):

It is possible to improve the regularity of the pores by once removing a part or all of the oxide film 24 to use this as a pore generating point 26 of anodization as illustrated in FIG. 2. It is possible to accomplish the purpose to remove the oxide film even in a state in which the oxide film 24 is not completely removed but partially remains as long as the remained part of the oxide film 24 already has sufficiently enhanced regularity.

Examples of the method to remove the oxide film 24 may include a method in which the oxide film 24 is dissolved in a solution that can selectively dissolve the oxide film 24 without dissolving aluminum and thus removed. Examples of such a solution may include a mixed solution of chromic acid/phosphoric acid.

Process (c):

As illustrated in FIG. 2, the oxide film 24 having the cylindrical pore 22 is formed by anodizing again the aluminum substrate 20 obtained by removing the oxide film.

The anodization can be performed under the same conditions as in the process (a). It is possible to obtain a deeper pore as the time for anodization is longer.

Process (d):

As illustrated in FIG. 2, a treatment to expand the size of the pore 22 (hereinafter, referred to as the “pore size expanding treatment”) is performed. The pore size expanding treatment is a treatment in which the oxide film 24 is immersed in a solution capable of dissolving it and thus the size of the pore obtained by anodization is expanded. Examples of such a solution may include an aqueous solution of phosphoric acid at about 5% by mass.

The pore size is greater as the time for pore size expanding treatment is longer.

Process (e):

As illustrated in FIG. 2, the cylindrical pore 22 is further formed which further extends down from the bottom of the cylindrical pore 22 and has a smaller diameter by performing the anodization again.

The anodization can be performed under the same conditions as in the process (a). It is possible to obtain a deeper pore as the time for anodization is longer.

Process (f):

As illustrated in FIG. 2, the oxide film 24 having the pore 22 with a shape of which the diameter continuously decreases in the depth direction from the opening is formed by repeating the pore size expanding treatment of the process (d) and the anodization of the process (e). This makes it possible to obtain a mold 28 having anodized alumina (porous aluminum oxide film (anodized aluminum)) on the surface of the aluminum substrate 20. It is preferable to terminate by the process (d) at the end.

The number of repetition is preferably 3 times or more and more preferably 5 times or more in total. A moth-eye structure that has a continuously decreasing pore diameter and a sufficient reflectance decreasing effect is obtained when the number of repetition is 3 times or more.

Examples of the shape of the pore 22 may include a substantially conical shape, a pyramid shape and a cylindrical shape. A shape such as a conical shape and a pyramid shape is preferable in which the pore cross-sectional area in the direction orthogonal to the depth direction continuously decreases in the depth direction from the outermost surface.

The average interval between the adjacent pores 22 is preferably equal to or less than the wavelength of visible light, that is, 400 nm or less, more preferably from 25 to 300 nm and even more preferably from 80 to 250 nm.

The average interval between the adjacent pores 22 is the value determined by measuring the interval (distance from the center of the pore 22 to the center of the adjacent pore 22) between the adjacent pores 22 by an electron microscope at 50 points and averaging these values.

The average depth of the pores 22 is preferably from 100˜ to 400 nm and more preferably from 130 to 300 nm.

The average depth of the pores 22 is the value determined by measuring the distance between the bottommost part of the pore 22 and the topmost part of the convex portion present between the pores 22 at 50 points when observed by the electron microscope and averaging these values.

The aspect ratio of the pores 22 (the average depth of pores 22/average interval between the adjacent pores 22) is preferably from 0.3 to 4 and more preferably from 0.8 to 2.5.

The surface on the side where a fine relief structure is formed of the mold may be treated with a mold releasing agent.

Examples of the mold releasing agent may include a silicone resin, a fluorine resin, a fluorine compound and a phosphoric acid ester, and a fluorine compound and a phosphoric acid ester are preferable.

Examples of the commercially available product of the fluorine compound may include the “FLUORO LINK” manufactured by Solvay Specialty Polymers Japan K.K., the “KBM-7803” of a fluoroalkylsilane manufactured by Shin-Etsu Chemical Co., Ltd., the “MRAF” manufactured by ASAHI GLASS CO., LTD., the “OPTOOL HD1100” and “OPTOOL HD2100 series” manufactured by HARVES Co., Ltd., the “OPTOOL DSX” manufactured by DAIKIN INDUSTRIES, ltd., the “Novec EGC-1720” manufactured by 3M Japan Limited, and the “FS-2050” series manufactured by Fluoro Technology.

As the phosphoric acid ester, a (poly)oxyalkylene alkyl phosphoric acid compound is preferable. Examples of the commercially available product may include the “JP-506H” manufactured by JOHOKU CHEMICAL CO., LTD., the “MOLD WIZ INT-1856” manufactured by AXEL PLASTICS RESEARCH LABORATORIES, INC., and the “TDP-10”, “TDP-8”, “TDP-6”, “TDP-2”, “DDP-10”, “DDP-8”, “DDP-6”, “DDP-4”, “DDP-2”. “TLP-4”. “TCP-5” and “DLP-10” manufactured by Nikko Chemicals Co., Ltd.

One kind of these mold releasing agents may be used singly or two or more kinds thereof may be concurrently used.

The fine relief structure of the laminate structure is one formed by transferring the fine relief structure on the surface of the anodized alumina in a case in which the fine relief structure is formed by a transfer method using a mold that is obtained in this manner and thus has an anodized alumina on the surface of the aluminum substrate.

Hereinafter, a manufacturing apparatus for manufacturing a laminate structure and an example of a method for manufacturing a laminate structure using the manufacturing apparatus will be specifically described.

(Manufacturing Apparatus and Method for Manufacturing Laminate Structure)

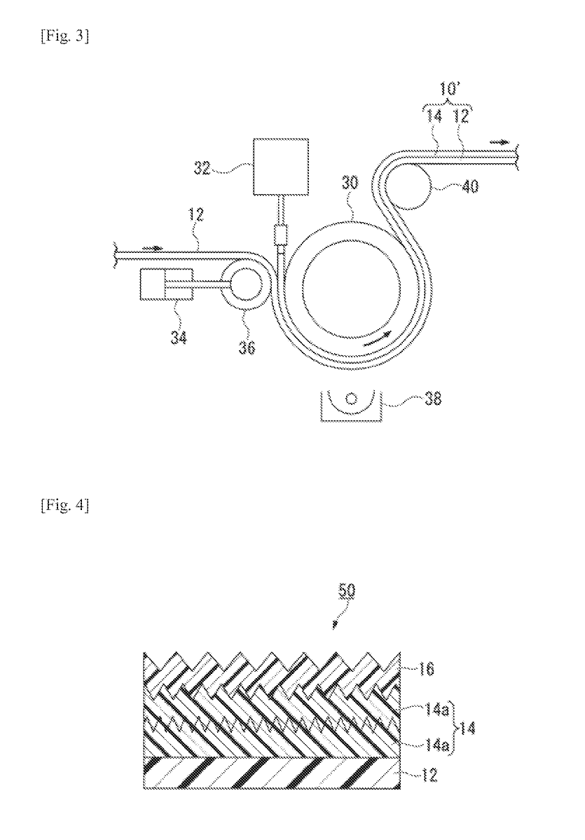

The laminate structure 10 illustrated in FIG. 1 is manufactured by the manufacturing method (1) including the following processes (1-1) and (1-2), for example, using the manufacturing apparatus illustrated in FIG. 3.

(1-1) A process of supplying an active energy ray-curable resin composition for an intermediate layer (resin composition for an intermediate layer) on a substrate, transferring a fine relief structure using a mold having a fine relief structure on the surface, subsequently curing the resin composition for an intermediate layer to which the fine relief structure is transferred by irradiating with an active energy ray to form an intermediate layer, and then peeling off the intermediate layer from the mold.

(1-2) A process of supplying an active energy ray-curable resin composition for an outermost layer (resin composition for an outermost layer) on the surface of the intermediate layer obtained after repeating the process (1-1) one or more times, transferring a fine relief structure using a mold having a fine relief structure on the surface, subsequently curing the resin composition for an outermost layer to which the fine relief structure is transferred by irradiating with an active energy ray to form an outermost layer, and then peeling off the outermost layer from the mold.

Process (1-1):

As illustrated in FIG. 3, the resin composition for an intermediate layer is supplied between a roll-shaped mold 30 having a reverse structure (not illustrated) of a fine relief structure on the surface and the substrate 12 which is a belt-shaped film moving along the surface of the roll-shaped mold 30 from a tank 32.

The substrate 12 and the resin composition for an intermediate layer are nipped between the roll-shaped mold 30 and a nip roll 36 having a nip pressure adjusted by a pneumatic cylinder 34. By virtue of this, the resin composition for an intermediate layer is uniformly spread through between the substrate 12 and the roll-shaped mold 30 and filled in the concave portion of the fine relief structure of the roll-shaped mold 30 at the same time, and thus the fine relief structure is transferred.

The resin composition for an intermediate layer to which the fine relief structure is transferred is irradiated with an active energy ray from an active energy ray irradiating device 38 which is installed below the roll-shaped mold 30 via the substrate 12 to cure the resin composition for an intermediate layer. By virtue of this, the intermediate layer 14 to which the fine relief structure on the surface of the roll-shaped mold 30 is transferred and thus has a fine relief structure on the surface is formed.

A laminate 10′ formed by laminating the intermediate layer 14 on the substrate 12 is obtained by peeling the substrate 12 on which the intermediate layer 14 having a fine relief structure on the surface is formed from the roll-shaped mold 30 by a peeling roll 40. The laminate 10′ thus obtained is used in the next process without subjecting the surface (the surface on the fine relief structure side) of the intermediate layer 14 to a release treatment.

Process (1-2):

The resin composition for an outermost layer is supplied between the laminate 10′ and the roll-shaped mold 30 from the tank 32 by moving the laminate 10′ instead of the substrate 12 along the surface of the roll-shaped mold 30 using the manufacturing apparatus illustrated in FIG. 3 again. The laminate 10′ and the resin composition for an outermost layer are nipped between the roll-shaped mold 30 and the nip roll 36 having a nip pressure adjusted by the pneumatic cylinder 34. By virtue of this, the resin composition for an outermost layer is uniformly spread through between the laminate 10′ and the roll-shaped mold 30 and filled in the concave portion of the fine relief structure of the roll-shaped mold 30 at the same time, and thus the fine relief structure is transferred.

Subsequently, the resin composition for an outermost layer to which the fine relief structure is transferred is irradiated with an active energy ray via the substrate 12 to cure the resin composition. By virtue of this, the outermost layer 16 to which the fine relief structure on the surface of the roll-shaped mold 30 is transferred and thus has a fine relief structure on the surface is formed.

Subsequently, the laminate 10′ on which the outermost layer 16 having a fine relief structure on the surface is formed is peeled off from the roll-shaped mold 30 by the peeling roll 40, thereby obtaining the laminate structure 10 in which the intermediate layer 14 and the outermost layer 16 which have a fine relief structure on the surfaces are laminated on the substrate 12 in order as illustrated in FIG. 1.

As the active energy ray irradiating device 38, a high pressure mercury lamp, a metal halide lamp, an LED lamp and the like are preferable. The quantity of light irradiation energy is preferably from 100 to 10000 mJ/cm².

Meanwhile, the intermediate layer 14 and the outermost layer 16 may be formed using the same manufacturing apparatus or different manufacturing apparatuses.

It is possible to prevent the manufacturing apparatus from increasing in size in the case of using the same manufacturing apparatus. In this case, the mold is replaced to the mold for outermost layer when the process is switched from the formation of the intermediate layer 14 to the formation of the outermost layer 16 in a case in which the shapes of the concave portion and convex portion of the relief structure are different in each layer.

The intermediate layer 14 and the outermost layer 16 can be continuously formed in the case of using different manufacturing apparatuses.

<Effect>

The laminate structure 10 of the first aspect described above includes the intermediate layer 14 having a fine relief structure on the surface, and thus it is excellent in adhesion between the intermediate layer 14 and the outermost layer 16 adjacent to the intermediate layer 14 by an anchor effect due to the fine relief structure. In addition, the interface of the laminate structure 10 is not release treated and thus it is difficult to peel off an arbitrary layer although intentional peeling is attempted and high adhesion is exhibited between the layers.

For example, the laminate structure 10 exhibits the adhesion such that the number of notches that are peeled off when 100 squares (10×10) of grid-shaped notches are formed on the surface (topmost surface) the laminate structure 10 at an interval of 2.0 mm and a pressure sensitive adhesive tape is pasted to this notch part at a pressing load of 0.1 MPa and then peeled off therefrom is less than 50 squares among the 100 squares in the cross-cut tape peeling test performed in conformity with JIS K 5600-5-6: 1999 (ISO 2409: 1992).

In addition, the laminate structure 10 has a multilayer structure, and thus excoriation resistance is improved and the mechanical properties of the surface of the laminate structure 10 are enhanced. Particularly, the laminate structure 10 is superior in the mechanical properties since the intermediate layer 14 is provided between the substrate 12 and the outermost layer 16. The excoriation resistance and pencil hardness of the surface of the laminate structure 10 tend to be further improved when the thickness of the intermediate layer 14 is increased or the intermediate layer 14 is formed of a hard material, a material that exhibits a strong restoring force or a material that absorbs the stress.

As described above, the laminate structure 10 of the first aspect exhibits high adhesion between the layers (intermediate layer 14 and outermost layer 16) and excellent mechanical properties.

In addition, the laminate structure 10 exhibits high adhesion between the layers and thus can be manufactured at low cost without a need to provide an adhesion promoting layer or a primer layer on the surface of the substrate or to roughen the surface of the substrate.

Moreover, the laminate structure 10 of the first aspect has a fine relief structure even on the surface of the outermost layer 16 and thus is excellent in optical performance such as antireflection performance.

Incidentally, as the method to increase the adhesion between the outermost layer and the intermediate layer in the laminate equipped with an intermediate layer, a method is known in which the resin composition for an intermediate layer is not cured or is weakly cured when forming the intermediate layer on the substrate. The surface of the intermediate layer may adhere to the conveying roll in the stage before forming the outermost layer on the surface of the intermediate layer or blocking occurs when overlapping the substrate on which the intermediate layer is laminated in some cases when the intermediate layer is formed on the substrate by this method.

However, the laminate structure 10 illustrated in FIG. 1 is excellent in adhesion between the outermost layer 16 and the intermediate layer 14 since a fine relief structure is formed on the surface of the intermediate layer 14. Hence, the surface of the intermediate layer 14 hardly adheres to the conveying roll or blocking hardly occurs when overlapping the substrate 12 on which the intermediate layer 14 is laminated since there is no need not to cure or to weakly cure the resin composition for an intermediate layer.

In addition, the fine relief structure is characterized by the pitch of the convex portions, the average height of convex the portions, and the aspect ratio which is the balance between the pitch of the convex portions and the average height of the convex portions. For example, the adhesion between the layers tends to be excellent as the pitch of the convex portions is narrower, the average height of the convex portions is higher, and the aspect ratio is greater. On the other hand, the excoriation resistance of the surface of the laminate structure 10 tends to be improved and the phenomenon that the adjacent convex portions get close to each other and thus fine relief structure is in poor shape is less likely to occur as the pitch of the convex portions is wider, the average height of the convex portions is lower, and the aspect ratio is smaller.

In the laminate structure 10 illustrated in FIG. 1, the average height of the convex portions of the fine relief structure is the same in the intermediate layer 14 and the outermost layer 16, but the pitch of the convex portions of fine relief structure of the outermost layer 16 is greater than that of the fine relief structure of the intermediate layer 14 and the aspect ratio of fine relief structure of the outermost layer 16 is smaller than that of the fine relief structure of the intermediate layer 14. Hence, the laminate structure 10 in which a fine relief structure having a wider pitch and a smaller aspect ratio is formed on the surface of the outermost layer 16 and a fine relief structure having a narrower pitch and a larger aspect ratio is formed on the surface of the intermediate layer 14 exhibits a favorable balance between the adhesion and excoriation resistance. Moreover, the pitch of the convex portions of the fine relief structure is different in the intermediate layer 14 and the outermost layer 16, and thus it is possible to differently dispose these fine relief structures only by laminating the outermost layer 16 on the intermediate layer 14.

In addition, it is possible to freely design the shape of the fine relief structure of each layer when the fine relief structure is formed by a transfer method using a mold. Moreover, it is possible to easily manufacture a laminate structure in which the concave portion and convex portion of the fine relief structure of an arbitrary layer are differently disposed from the concave portion and convex portion of the fine relief structure of another at least one layer.

Incidentally, the surface of the coating layer (outermost layer) formed also has a fine relief structure to follow the shape of the surface of the lower layer (intermediate layer), for example, when the intermediate layer is coated with an arbitrary coating material so as to follow the shape of the surface of a layer (intermediate layer) having a fine relief structure on the surface. However, the fine relief structures of the respective layers are not differently disposed in this case. Moreover, it is difficult to form fine relief structures which are different in the pitch of the convex portions, the average height of the convex portions and the aspect ratio on the intermediate layer and the coating layer (outermost layer).

In addition, the unevenness in thickness of the coating layer (outermost layer) easily occurs and thus a skilled coating technique is required in order to form a coating layer (outermost layer) having a uniform thickness in the case of forming a coating layer (outermost layer) so as to follow the shape of the surface of a layer (intermediate layer) having a fine relief structure on the surface. Moreover, there is a concern that the coating material is not sufficiently filled into the concave portion of the fine relief structure of the intermediate layer and thus a gap is formed between the intermediate layer and the coating layer (outermost layer). The coating material is hardly filled in the concave portion particularly in a case in which the convex portion is high (concave portion is deep) or the pitch of the convex portions or the concave portions is narrow.

However, the outermost layer 16 having a uniform thickness can be easily formed when using a transfer method. In addition, the resin composition is sufficiently filled into the concave portion of the intermediate layer 14 and thus a gap is less likely to be formed between the intermediate layer 14 and the outermost layer 16. Moreover, it is possible to easily form the fine relief structures which are different in the pitch of the convex portions, the average height of the convex portions and the aspect ratio on the intermediate layer 14 and the outermost layer 16 only by changing the molds at the time of forming the intermediate layer 14 and at the time of forming the outermost layer 16.

(Application)

It is expected that the laminate structure of the first aspect is utilized in the application as an antireflective article (an antireflective film, an antireflective membrane and the like), an optical article (a waveguide, a relief hologram, a lens, a polarization-separation element and the like), a cell culture sheet, an ultra-water-repellent article and a super-hydrophilic article. It is particularly suitable for the application as an antireflective article among these.

Examples of the antireflective article may include an antireflective membrane, an antireflective film and an antireflective sheet which are provided on the surface of an image display device (a liquid crystal display device, a plasma display panel, an electroluminescence display, a cathode ray tube display device and the like), a lens, a show window, a spectacle and the like.

For example, in the case of using an antireflective article in an image display device, an antireflective film may be directly pasted onto the image display surface as the antireflective article, an antireflective membrane may be directly formed on the surface of a member constituting the image display surface as the antireflective article, or an antireflective film may be formed on the front plate as the antireflective article.

### Other Embodiments

The laminate structure of the first aspect is not limited to those described above. In the laminate structure 10 illustrated in FIG. 1, the intermediate layer 14 is constituted by a single layer but the intermediate layer 14 may be constituted by a plurality of layers, for example, as illustrated in FIGS. 4 and 5. The materials, film thicknesses and physical properties (mechanical properties, optical performance and the like) of the respective layers may be the same as or different from one another in a case in which the intermediate layer is constituted by a plurality of layers.

A laminate structure 50 illustrated in FIG. 4 is constituted by laminating the intermediate layer 14 and the outermost layer 16 on the substrate 12 in order. The intermediate layer 14 of the laminate structure 50 consists of two layers of layers 14a and 14a which have a fine relief structure on the surfaces and the outermost layer 16 also has a fine relief structure on the surface. The concave portion and convex portion of the fine relief structure of the outermost layer 16 are differently disposed from the concave portions and convex portions of the fine relief structures of the layers 14a and 14a which have a fine relief structure on the surfaces and constitute the intermediate layer 14, and the fine relief structures of the layers 14a and 14a which have a fine relief structure on the surfaces also have different dispositions.

Meanwhile, in the laminate structure 50 illustrated in FIG. 4, the pitches of the convex portions and the aspect ratios of all the fine relief structures are different from one another and all of the fine relief structures have different dispositions, but the fine relief structure of the remainder may not have a different disposition from either one of the two fine relief structures as long as at least two fine relief structures have different dispositions. In addition, the layers having fine relief structures with different dispositions on the surfaces may be or may not be adjacent to one another.

A laminate structure 60 illustrated in FIG. 5 is constituted by laminating the intermediate layer 14 and the outermost layer 16 on the substrate 12 in order. The intermediate layer 14 of the laminate structure 60 consists of two layers of a layer 14a which has a fine relief structure on the surface and 14b which does not have a fine relief structure on the surface and the outermost layer 16 also has a fine relief structure on the surface. The concave portion and convex portion of the fine relief structure of the outermost layer 16 are differently disposed from the concave portion and convex portion of the fine relief structure of the layer 14a which has a fine relief structure on the surface and constitutes the intermediate layer 14. Examples of the material for the layer 14b which does not have a fine relief structure on the surface may include a thermoplastic resin, an active energy ray-curable resin composition and an inorganic material.

Meanwhile, in the laminate structure 60 illustrated in FIG. 5, the outermost layer 16 and the layer 14a which has a fine relief structure on the surface are adjacent to each other but the outermost layer 16 and the layer 14b which does not have a fine relief structure on the surface may be adjacent to each other.

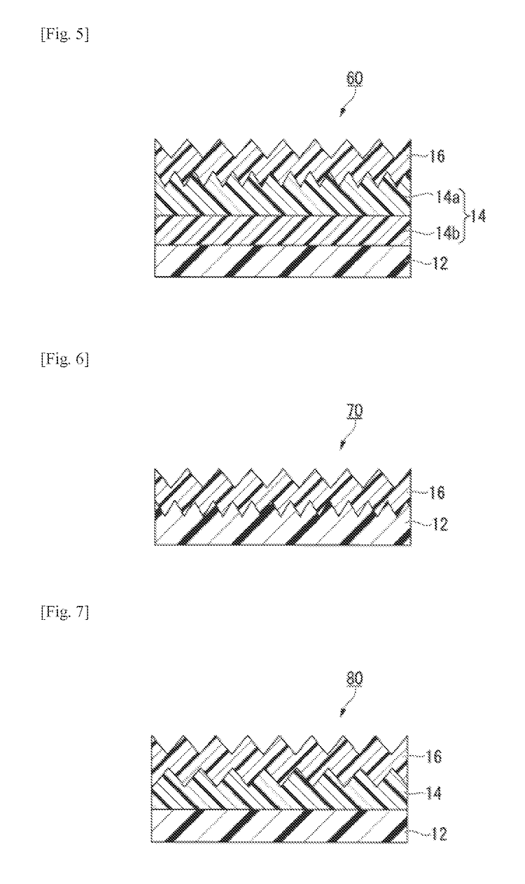

In addition, in the laminate structures 10, 50, and 60 illustrated in FIGS. 1, 4, and 5, the intermediate layer 14 is provided between the substrate 12 and the outermost layer 16 but the outermost layer 16 may be directly laminated on the substrate 12, for example, as illustrated in FIG. 6.

A laminate structure 70 illustrated in FIG. 6 is constituted by laminating the outermost layer 16 on the substrate 12. The substrate 12 and outermost layer 16 of the laminate structure 70 have a fine relief structure on the surfaces, and the concave portion and convex portion of the fine relief structure of the outermost layer 16 are differently disposed from the concave portion and convex portion of the fine relief structure of the substrate 12. However, it is preferable that an intermediate layer is provided between the substrate 12 and the outermost layer 16 in order to exert superior mechanical properties such as excoriation resistance.

In addition, in the laminate structures 10, 50, 60 and 70 illustrated in FIGS. 1 and 4 to 6, the pitches of the convex portions and the aspect ratios of the fine relief structures of the respective layers are different from one another but the pitches of the convex portions, the aspect ratios and the like of the fine relief structures of the respective layers may be the same as one another, for example, as illustrated in FIG. 7 as long as the fine relief structures of at least two layers have different dispositions.

However, it is easy to adjust the adhesion between the layers and the like when the pitches of the convex portions of the fine relief structures of the respective layers are different from one another.

A laminate structure 80 illustrated in FIG. 7 is constituted by laminating the intermediate layer 14 and the outermost layer 16 on the substrate 12 in order. The intermediate layer 14 and outermost layer 16 of the laminate structure 80 have a fine relief structure on the surfaces, and the concave portion and convex portion of the fine relief structure of the outermost layer 16 are differently disposed from the concave portion and convex portion of the fine relief structure of the intermediate layer 14. Furthermore, the fine relief structures of the intermediate layer 14 and the outermost layer 16 are the same in the pitch of the convex portions, the average height of the convex portions and the aspect ratio. Incidentally, it is possible to effectively decrease the undesired diffraction or interference derived from the structure when the fine relief structures which are the same in the pitch of the convex portions, the average height of the convex portions and the aspect ratio are positioned to be mismatched with each other.

In addition, in the laminate structures 10, 50, 60, 70 and 80 illustrated in FIGS. 1 and 4 to 7, the shapes of the concave portions and convex portions of the fine relief structures of the respective layers are the same (substantially conical shape in the case of FIGS. 1 and 4 to 7) as one another, but the shapes of the concave portions and convex portions of the fine relief structures of the respective layers may be different from one another and may be appropriately selected depending on the effect required to the fine relief structure.

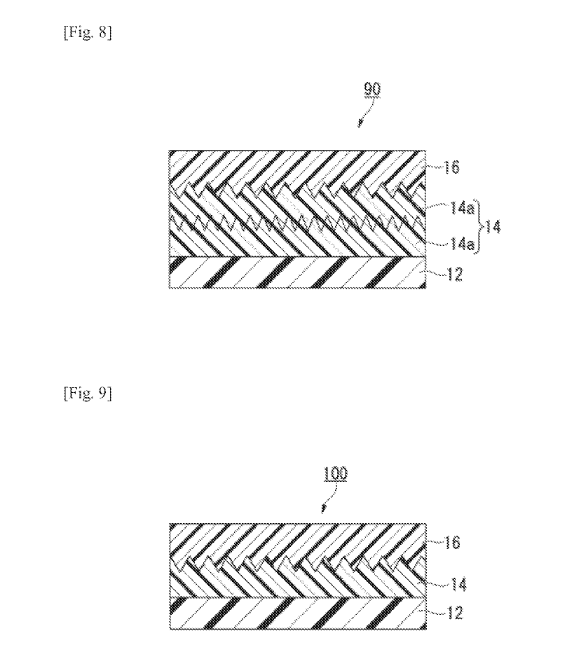

In addition, in these laminate structures 10, 50, 60, 70 and 80, a fine relief structure is formed at least on the surface of the outermost layer 16, but a fine relief structure may not be formed on the surface of the outermost layer 16, for example, as illustrated in FIG. 8 as long as at least two layers have a fine relief structure on the surfaces. In addition, a fine relief structure may be formed on the back surface of the substrate 12. However, it is preferable that at least the outermost layer 16 has a fine relief structure on the surface in order to exert excellent optical performance such as antireflection performance.

A laminate structure 90 illustrated in FIG. 8 is constituted by laminating the intermediate layer 14 and the outermost layer 16 on the substrate 12 in order. The intermediate layer 14 of the laminate structure 90 consists of two layers of layers 14a and 14a which have a fine relief structure on the surfaces and the outermost layer 16 does not have a fine relief structure on the surface. The concave portion and convex portion of the fine relief structure of one of the layers 14a and 14a which have a fine relief structure on the surfaces are differently disposed from the concave portions and convex portions of the fine relief structures of the other.

The outermost layer 16 of the laminate structure 90 may be a coating layer. As illustrated in FIG. 8, the coating layer comes into close contact with the intermediate layer 14 when the intermediate layer 14 adjacent to the coating layer has a fine relief structure on the surface.

Furthermore, a separate film may be provided on the back surface of the substrate 12 via a pressure sensitive adhesive material layer. It is possible to easily paste the laminate structure to another film-shaped or sheet-shaped article (a front plate, a polarizing element and the like) by providing the pressure sensitive adhesive material layer.

In addition, the method for manufacturing a laminate structure is not limited to the manufacturing method (1) described above.

The laminate structure can also be manufactured, for example, by either method of the following manufacturing methods (2) and (3) in the case of manufacturing a laminate structure having a fine relief structure formed on the surface of the outermost layer 16.

The manufacturing method (2) is a method including the following processes (2-1) and (2-2).

(2-1) A process of supplying a resin composition for an outermost layer on the surface of a mold having a fine relief structure on the surface and transferring the fine relief structure of the mold.

(2-2) A process of disposing a substrate on which an intermediate layer having a fine relief structure on the surface is laminated on the resin composition for an outermost layer on the mold such that the intermediate layer side is in contact therewith, subsequently curing the resin composition for an outermost layer to which the fine relief structure is transferred by irradiating with an active energy ray to form an outermost layer, and then peeling off the outermost layer from the mold.

In the process (2-1), the resin composition for an outermost layer is filled in the concave portion of the fine relief structure of the mold and the fine relief structure of the mold is transferred to the resin composition for an outermost layer as the resin composition for an outermost layer is supplied onto the surface of the mold.

In the process (2-2), the resin composition for an outermost layer is uncured in the stage to dispose the substrate on which an intermediate layer having a fine relief structure on the surface is laminated on the resin composition for an outermost layer. Hence, the uncured resin composition for an outermost layer is easily filled even in the concave portion of the fine relief structure of the intermediate layer. The substrate on which an intermediate layer having a fine relief structure on the surface is laminated is integrated with the outermost layer while the outermost layer is formed as the resin composition for an outermost layer is cured in this state.

The method for laminating the intermediate layer having a fine relief structure on the surface on the substrate is not particularly limited, and examples thereof may include the method of the process (1-1) described above. The surface of the intermediate layer is not release treated.

The manufacturing method (3) a method including the following processes (3-1) and (3-2).

(3-1) A process of supplying a resin composition for an outermost layer on the surface of a mold having a fine relief structure on the surface, transferring the fine relief structure of the mold, and subsequently semi-curing the resin composition for an outermost layer to which the fine relief structure is transferred by irradiating with an active energy ray.

(3-2) A process of disposing a substrate on which an intermediate layer having a fine relief structure on the surface is laminated on the semi-cured resin composition for an outermost layer on the mold such that the intermediate layer side is in contact therewith, subsequently curing the semi-cured resin composition for an outermost layer by irradiating with an active energy ray to form an outermost layer, and then peeling off the outermost layer from the mold.

The manufacturing method (3) is the same as the manufacturing method (2) except that the resin composition of outermost layer to which the fine relief structure is transferred is semi-cured in the process (3-1).

Here, the term “semi-cured” refers to the state of being cured to the extent to which the resin composition does not flow and specifically refers to that the viscosity after semi-curing is 10000 mPa·s or more or the resin composition exhibits a hardness corresponding to 80% or less of the hardness when cured (complete curing) in the process (3-2).

The manufacturing methods (1) to (3) described above are a method for manufacturing a laminate structure equipped with a substrate which does not have a fine relief structure on the surface, but for example, any method of the following manufacturing methods (5) to (7) may be used in the case of manufacturing a laminate structure equipped with a substrate which has a fine relief structure on the surface.

A manufacturing method (5) is a manufacturing method including the following process (5-1).

(5-1) A process of supplying a resin composition for an outermost layer on the surface of a substrate having a fine relief structure on the surface, transferring a fine relief structure using a mold having a fine relief structure on the surface, subsequently curing the resin composition for an outermost layer to which the fine relief structure is transferred by irradiating with an active energy ray to form an outermost layer, and then peeling off the outermost layer from the mold.

In the process (5-1), a substrate of which the surface is not release treated is used.

In addition, in the process (5-1), an intermediate layer may be formed on the surface of a substrate before supplying a resin composition for an outermost layer on the surface of the substrate having a fine relief structure on the surface. The method for forming the intermediate layer is not particularly limited, and examples thereof may include a known method such as a laminate molding method, a casting method, a coating method and a transfer method which will be described below. In addition, a fine relief structure may be formed on the surface of the intermediate layer, for example, by the transfer method using a mold described in the process (1-1) above. Meanwhile, the surface of the intermediate layer is not release treated.

A manufacturing method (6) is a method including the following processes (6-1) and (6-2).

(6-1) A process of supplying a resin composition for an outermost layer on the surface of a mold having a fine relief structure on the surface and transferring the fine relief structure of the mold.

(6-2) A process of disposing a substrate having a fine relief structure on the surface on the resin composition for an outermost layer on the mold such that the fine relief structure side is in contact therewith, subsequently curing the resin composition for an outermost layer to which the fine relief structure is transferred by irradiating with an active energy ray to form an outermost layer, and then peeling off the outermost layer from the mold.

A manufacturing method (7) is a method including the following processes (7-1) and (7-2).

(7-1) A process of supplying a resin composition for an outermost layer on the surface of a mold having a fine relief structure on the surface, transferring the fine relief structure of the mold, and subsequently semi-curing the resin composition for an outermost layer to which the fine relief structure is transferred by irradiating with an active energy ray.

(7-2) A process of disposing a substrate having a fine relief structure on the surface on the semi-cured resin composition for an outermost layer on the mold such that the fine relief structure side is in contact therewith, subsequently curing the semi-cured resin composition for an outermost layer by irradiating with an active energy ray to form an outermost layer, and then peeling off the outermost layer from the mold.

In the processes (6-2) and (7-2), a substrate of which the surface is not release treated is used.

In addition, in the substrate used in the processes (6-2) and (7-2), an intermediate layer may be laminated on the surface on the fine relief structure side of the substrate, and in this case, the substrate on which the intermediate layer is laminated is disposed on the resin composition for an outermost layer such that the intermediate layer side is in contact with the resin composition for an outermost layer. In addition, the intermediate layer may have a fine relief structure on the surface.

The method for forming the intermediate layer on the substrate is not particularly limited, and examples thereof may include a known method such as a laminate molding method, a casting method, a coating method and a transfer method which will be described below. In addition, the method for laminating the intermediate layer having a fine relief structure on the surface is not also particularly limited, and examples thereof may include a method of the process (1-1) described above. Meanwhile, the surface of the intermediate layer is not release treated.

In addition, in the case of manufacturing a laminate structure in which a fine relief structure is not formed on the surface of the outermost layer 16 as illustrated in FIG. 8, for example, a method of the following manufacturing method (9) may be used.

The manufacturing method (9) is a method including the following processes (9-1) and (9-2).

(9-1) A process of supplying an active energy ray-curable resin composition for an intermediate layer on a substrate, transferring a fine relief structure using a mold having a fine relief structure on the surface, subsequently curing the active energy ray-curable resin composition for an intermediate layer to which the fine relief structure is transferred by irradiating with an active energy ray to form an intermediate layer, and then peeling off the intermediate layer from the mold.

(9-2) A process of forming an outermost layer on the surface of the intermediate layer obtained after repeating the process (9-1) two or more times.

The process (9-1) is the same as the process (1-1) described in the first aspect. Meanwhile, the surface of the intermediate layer 14 is not release treated.

In the process (9-2), the method for forming the outermost layer on the surface of the intermediate layer is not particularly limited, and examples thereof may include a known method such as a laminate molding method, a casting method, a coating method and a transfer method.

Examples of the laminate molding method may include a method in which the resin composition of the outermost layer is extruded on the surface of the intermediate layer in a molten state, laminated and cooled by a cooling means such as a cooling roll.

Examples of the casting method and coating method may include a method in which the resin composition of the outermost layer described above is dissolved or dispersed in a single substance or a mixture of organic solvents such as toluene, MEK and ethyl acetate, a solution having a solid matter concentration of about from 0 to 70% by mass is prepared, this is spread out by an appropriate spreading method such as a casting method or a coating method, dried, and then cured with an active energy ray so as to directly provide the resin composition on the surface of the intermediate layer.

Examples of the transfer method may include a method in which the resin composition of the outermost layer is filled between the transfer roll (mold) having a mirror finished surface and the intermediate layer side of the substrate on which an intermediate layer is laminated and uniformly spread through between the intermediate layer and the transfer roll, and the resin composition of the outermost layer is cured by irradiating with an active energy ray.

In addition, in the process (9-2), a coating layer may be formed by coating the surface of the intermediate layer with an arbitrary coating material so as not to follow the shape (fine relief structure) of the surface of the intermediate layer and the coating layer may be used as the outermost layer. A fine relief structure is not formed on the surface of the coating layer (outermost layer) in this case.

Meanwhile, in the manufacturing method (9), the outermost layer is formed after forming the intermediate layer having a fine relief structure on the surface on the substrate, but the outermost layer may be directly formed on the surface of the substrate having a fine relief structure on the surface as a process (8-1) to be described below. In addition, the outermost layer may be formed after forming the intermediate layer of one or more layers on the substrate having a fine relief structure on the surface. In this case, a fine relief structure may be formed on the surface of the intermediate layer if necessary, for example, by a transfer method using a mold.

<<Second Aspect>>

The laminate structure according to the second aspect of the invention is constituted by laminating two or more layers, and the outermost layer is a layer which does not have a fine relief structure on the surface and at least one layer other than the outermost layer has a fine relief structure on the surface.

FIG. 9 is a cross-sectional view illustrating an example of the laminate structure according to the second aspect.

A laminate structure 100 of this example is constituted by laminating the intermediate layer 14 and the outermost layer 16 on the substrate 12 in order, and the intermediate layer 14 has a fine relief structure on the surface.

The average interval between the convex portion, the average height, and the aspect ratio of the fine relief structure are the same as those of the first aspect.

In addition, the substrate 12 and the resin composition constituting the intermediate layer 14 and the outermost layer 16 are the same as those of the first aspect.

Meanwhile, in the second aspect, the interface of the laminate structure may be release treated or may not be release treated, but it is preferable that the interface of the laminate structure is not release treated.

<Method for Manufacturing Laminate Structure>

The method for forming the fine relief structure of the intermediate layer 14 is not particularly limited, but it is preferable that the fine relief structure is formed by a transfer method using a mold, specifically, by bringing the resin composition for an intermediate layer into contact with the mold having the reverse structure of a fine relief structure on the surface and curing.

The transfer method using a mold and the mold and manufacturing apparatus used in that case are the same as those of the first aspect.

The laminate structure 100 illustrated in FIG. 9 is manufactured, for example, by a manufacturing method (4) including the following processes (4-1) and (4-2).

(4-1) A process of supplying a resin composition for an intermediate layer on a substrate, transferring a fine relief structure using a mold having a fine relief structure on the surface, subsequently curing the resin composition for an intermediate layer to which the fine relief structure is transferred by irradiating with an active energy ray to form an intermediate layer, and then peeling off the intermediate layer from the mold.

(4-2) A process of forming an outermost layer on the surface of the intermediate layer obtained after repeating the process (4-1) one or more times.

The process (4-1) is the same as the process (1-1) described in the first aspect. However, in the process (4-1), the surface of the intermediate layer may be or may not be release treated, but it is preferable the surface of the intermediate layer is not release treated.

The process (4-2) is the same as the process (9-2) described in the first aspect.

<Effect>

The laminate structure 100 of the second aspect described above includes the intermediate layer 14 having a fine relief structure on the surface, and thus it is excellent in adhesion between the intermediate layer 14 and the outermost layer 16 adjacent to the intermediate layer 14 by an anchor effect due to the fine relief structure. It is difficult to peel off an arbitrary layer although intentional peeling is attempted and adhesion between the layers is improved particularly when the interface of the laminate structure 100 is not release treated. For example, the laminate structure 100 exhibits the adhesion such that the number of notches peeled off when the cross-cut tape peeling test described above is performed is less than 50 squares among the 100 squares.

In addition, the laminate structure 10 has a multilayer structure, and thus excoriation resistance is improved and the mechanical properties of the surface of the laminate structure 100 are enhanced. Particularly, the laminate structure 100 is superior in the mechanical properties since the intermediate layer 14 is provided between the substrate 12 and the outermost layer 16. The excoriation resistance and pencil hardness of the surface of the laminate structure 10 tend to be further improved when the thickness of the intermediate layer 14 is increased or the intermediate layer 14 is formed of a hard material, a material that exhibits a strong restoring force or a material that absorbs the stress.

As described above, the laminate structure 100 of the second aspect exhibits high adhesion between the layers (intermediate layer 14 and outermost layer 16) and excellent mechanical properties.

In addition, the laminate structure 100 exhibits high adhesion between the layers and thus can be manufactured at low cost without a need to provide an adhesion promoting layer or a primer layer on the surface of the substrate or to roughen the surface of the substrate.

(Application)

The laminate structure of the second aspect is suitable for the application as an antireflective article which is excellent in adhesion between the layers, a coating article, an ultra-water-repellent article, a super-hydrophilic article, a fingerprint-proof article and an antifouling article by appropriately selecting the material for each layer.

### Other Embodiments

The laminate structure of the second aspect is not limited to those described above. In the laminate structure 100 illustrated in FIG. 9, the intermediate layer 14 is constituted by a single layer but the intermediate layer 14 may be constituted by a plurality of layers. The materials, film thicknesses and physical properties (mechanical properties, optical performance and the like) of the respective layers may be the same as or different from one another in a case in which the intermediate layer is constituted by a plurality of layers.

In addition, in the laminate structure 100 illustrated in FIG. 9, a fine relief structure is formed only on the surface of the intermediate layer 14 but the fine relief structure may be formed on the surfaces of two or more layers, and for example, the fine relief structure may be formed on the surface of the substrate 12. Furthermore, in a case in which the intermediate layer 14 is constituted by a plurality of layers, the fine relief structure may be formed on the surfaces of two or more layers among them.

Meanwhile, in a case in which the fine relief structure is formed on the surfaces of two or more layers, it is preferable that the concave portion and convex portion of the fine relief structure of an arbitrary layer are differently disposed from the concave portion and convex portion of the fine relief structure of at least one layer.

In addition, the method for manufacturing a laminate structure is not limited to the manufacturing method (4) described above.

The manufacturing method (4) described above is a method for manufacturing a laminate structure equipped with a substrate which does not have a fine relief structure on the surface, but for example, the method of the following manufacturing method (8) may be used in the case of manufacturing a laminate structure equipped with a substrate which has a fine relief structure on the surface.

The manufacturing method (8) is a method including the following process (8-1).

(8-1) A process of forming an outermost layer on the surface of a substrate having a fine relief structure on the surface.

In the process (8-1), examples of the method for forming the outermost layer on the surface of the substrate may include the same method as in the process (9-1) described in the first aspect.

In addition, in the process (8-1), an intermediate layer may be formed on the surface of the substrate before forming the outermost layer on the surface of the substrate having a fine relief structure on the surface. The method for forming the intermediate layer is not particularly limited, and examples thereof may include a known method such as a laminate molding method, a casting method, a coating method and a transfer method which are described above. In addition, a fine relief structure may be formed on the surface of the intermediate layer, for example, by the transfer method using a mold of the process (1-1) and the like described in the first aspect.

### EXAMPLES

Hereinafter, the invention will be described in more detail with reference to Examples.

Various kinds of measurement and evaluation methods, the method for manufacturing a mold and the components used in each Example are as follows.

“Measurement and Evaluation”

(Measurement of Pore of Mold)

A part of the mold was cut, the surface and longitudinal section thereof were deposited with platinum for 1 minute and observed at an acceleration voltage of 3.00 kV using a field emission scanning electron microscope (“JSM-7400F” manufactured by JEOL Ltd.), the interval between the adjacent pores (distance from the center of a pore to the center of an adjacent pore) was measured at 50 points, and the average value thereof was adopted as the average interval between the adjacent pores.

In addition, the longitudinal section of the mold was observed, the distance between the bottommost part of the pore and the topmost part of the convex portion present between the pores was measured at 50 points, and the average value thereof was adopted as the average depth of the pores.

(Measurement of Convex Portion of Fine Relief Structure)

The surface and longitudinal section of the sample for measurement were deposited with platinum for 10 minutes when the intermediate layer and the outermost layer had been formed and observed at an acceleration voltage of 3.00 kV using a field emission scanning electron microscope (“JSM-7400F” manufactured by JEOL Ltd.), the interval between the adjacent convex portions (distance from the center of a convex portion to the center of an adjacent convex portion) was measured at 50 points, and the average value thereof was adopted as the average interval between the adjacent convex portions.

In addition, the cross section of the sample for measurement was observed, the distance between the bottommost part of the convex portion and the topmost part of the concave portion present between the convex portions was measured at 50 points, and the average value thereof was adopted as the average height of the convex portions.

Furthermore, the dispositions of the respective fine relief structures formed on the intermediate layer and the outermost layer were confirmed by the observation using an electron microscope.

(Measurement of Film Thickness of Intermediate Layer and Outermost Layer)

The film thickness of the laminate film including the substrate and the intermediate layer and/or the outermost layer was measured using a micrometer when the intermediate layer or the outermost layer had been formed and the film thickness of the laminate film including the substrate or the intermediate layer was subtracted therefrom, thereby estimating the film thicknesses of the intermediate layer and the outermost layer.

(Measurement of Elastic Modulus and Elastic Recovery Rate)

A large slide glass (“large slide glass, product No. S9213” manufactured by Matsunami Glass Ind., Ltd., size: 76 mm×52 mm) was used as the substrate. The resin composition used in the process 2 was coated on the substrate so that the thickness of the coating film was about 250 μm and this was irradiated with ultraviolet light at about 1000 mJ/cm² using a high pressure mercury lamp, thereby fabricating a test piece having the cured product of the resin composition formed on the substrate. This was used as the test piece for measuring the elastic modulus and elastic recovery rate.

The physical properties of the cured product of the test piece were measured by the evaluation program of the [pushing (100 mN/10 seconds)]→[creeping (100 mN and 10 seconds)]→[removing of load (100 mN/10 seconds)] using the Vickers indenter (tetrahedral diamond pyramid) and a micro-hardness tester (“Fisher scope HM2000XYp” manufactured by Fischer Instruments K.K.). The measurement was carried out in a thermostatic chamber (23° C. of temperature and 50% of humidity).

The elastic modulus and elastic recovery rate of the cured product of the resin composition used in the process 2 were calculated from the measurement results thus obtained by the analysis software (“WIN-HCU” developed by Fischer Instruments K.K.), and these were adopted as the elastic modulus and elastic recovery rate of the outermost layer.

(Evaluation of Adhesion)

The evaluation of adhesion was performed in conformity with the cross-cut tape peeling test (JIS K 5600-5-6: 1999 (ISO 2409: 1992)) except that the number of square was 100 squares and the evaluation criteria was as follows.

First, a transparent black acrylic resin plate having a thickness of 2.0 mm (“ACRYLITE EX #502 manufactured by Mitsubishi Rayon Co., Ltd., 50 mm×60 mm) was pasted to the back surface of the laminate structure having a fine relief structure on the surface (back surface of the substrate where the fine relief structure was not transferred) via an optical pressure sensitive adhesive, 100 squares (10×10) of grid-shaped notches were formed on the surface having the fine relief structure at an interval of 2 mm using a cutter knife so as to reach from the outermost layer to the substrate, and a pressure sensitive adhesive tape (“CELLOTAPE (registered trademark)” manufactured by NICHIBAN CO., LTD.) was bonded to the grid-shaped part at a pressing load of 0.1 MPa. Thereafter, the pressure sensitive adhesive tape was rapidly peeled off therefrom, the peeling state of the outermost layer was observed, and the adhesion was evaluated according to the following evaluation criteria.

◯: peeling occurred in less than 10 squares among the 100 squares.

Δ: peeling occurred in 10 or more squares and less than 50 squares among the 100 squares.

x: peeling occurred in 50 or more squares among the 100 squares.

(Evaluation of Excoriation Resistance)

A load of 400 g was applied to the steel wool of 2 cm² (“Bon Star #0000” manufactured by NihonSteelWool Co., Ltd.) placed on the surface of the laminate structure having a fine relief structure on the surface, and the both-way wear was conducted 10 times at a travel distance of 30 mm and a head speed of 30 mm/sec using a wear tester (“HEiDON TRIBOGEAR TYPE-30S” manufactured by Shinto Scientific Co., Ltd.). Thereafter, the appearance of the surface of the laminate structure was evaluated. Upon evaluating the appearance, a transparent black acrylic resin plate having a thickness of 2.0 mm (“ACRYLITE EX #502 manufactured by Mitsubishi Rayon Co., Ltd., 50 mm×60 mm) was pasted to the back surface of the laminate structure (back surface of the substrate where the fine relief structure was not transferred) via an optical pressure sensitive adhesive, the laminate structure was visually observed indoors by holding it to a fluorescent lamp, and the excoriation resistance was evaluated according to the following evaluation criteria.

⊙: the scratches are not confirmed.

◯: the scratches that can be confirmed are less than five and the excoriation sites are not clouded in white.

Δ: the scratches that can be confirmed are 5 or more and less than 20 and the excoriation sites are slightly clouded in white.

x: the scratches that can be confirmed are 20 or more and the excoriation sites are seen to be clearly clouded in white.

x*: the scratches are not almost confirmed but peeling of the outermost layer has occurred.

(Measurement of Reflectance)

A transparent black acrylic resin plate having a thickness of 2.0 mm (“ACRYLITE EX #502 manufactured by Mitsubishi Rayon Co., Ltd., 50 mm×60 mm) was pasted to the back surface of the laminate structure having a fine relief structure on the surface (back surface of the substrate where the fine relief structure was not transferred) via an optical pressure sensitive adhesive, and this was utilized as the sample. The relative reflectance of the surface of the sample (laminate structure side) was measured at an angle of incidence of 50 (a 5° specular reflection attachment device used) and a wavelength in the range of from 380 to 780 nm using a spectrophotometer (“UV-2450” manufactured by Shimadzu Corporation), the visible light reflectance was calculated in conformity with JIS R 3106: 1998 (ISO 9050: 1990), and the antireflection property was evaluated.

(Measurement of Haze)

A transparent glass plate (“large slide glass, product No. S9112” manufactured by Matsunami Glass Ind., Ltd., size: 76 mm×52 mm) was pasted to the back surface of the laminate structure having a fine relief structure on the surface (back surface of the substrate where the fine relief structure was not transferred) via an optical pressure sensitive adhesive, and this was utilized as the sample. The haze of the sample was measured using a haze meter (“NDH2000” manufactured by NIPPON DENSHOKU INDUSTRIES Co., LTD.), and the transparency was evaluated.

(Evaluation of Blocking Resistance)

Two pieces of laminate film (50×50 mm) on which the intermediate layer obtained in the “process 1: formation of intermediate layer” to be described below was laminated were overlapped each other such that the surface of the intermediate layer was in contact with the surface on which the intermediate layer was not formed of the substrate, and allowed to stand for one day in a state that a load of 800 g was applied thereto, the state of the two laminate films was then observed, and the blocking resistance was evaluated according to the following evaluation criteria.

◯: there is no sticking between the laminate films.

x: the laminate films are stuck to each other.

“Fabrication of Mold”

(Fabrication of Mold A)

An aluminum disk having a purity of 99.99% by mass, a thickness of 2 mm and a diameter of 65 mm was subjected to the fabric polishing and the electrolytic polishing, and this was used as the aluminum substrate.

A 0.3 M aqueous solution of oxalic acid was adjusted to be at 16° C., and the aluminum substrate was immersed in this and subjected to the anodization at a direct current of 40 V for 30 minutes. This allowed an oxide film having pores to be formed on the aluminum substrate (process (a)).

Subsequently, the aluminum substrate having an oxide film formed thereon was immersed in an aqueous solution obtained by mixing phosphoric acid of 6% by mass and chromic acid of 1.8% by mass at 70° C. for 6 hours. This allowed the oxide film to be dissolved and removed (process (b)).

The aluminum substrate from which the oxide film was dissolved and removed was immersed in a 0.3 M aqueous solution of oxalic acid adjusted at 16° C. and subjected to the anodization at 40 V for 30 seconds (process (c)).

Subsequently, the aluminum substrate was immersed in a 5% by mass aqueous solution of phosphoric acid adjusted at 32° C. for 8 minutes so as to conduct the pore size expanding treatment to expand the pores of the oxide film (process (d)). The anodization and the pore size expanding treatment were conducted 5 times in total for each by alternately repeating them (processes (e) and (f)), thereby obtaining a mold in which anodized alumina having substantially conical-shaped pores with an average interval of 100 nm and an average depth of 180 nm was formed on the surface.

The mold thus obtained was immersed in a mold releasing agent (0.10% by mass aqueous solution of “TDP-8” manufactured by Nikko Chemicals Co., Ltd.) for 10 minutes and the mold was then withdrawn therefrom and air-dried for the night, thereby obtaining the mold A that is release-treated.

(Fabrication of Mold B)

An aluminum disk having a purity of 99.99% by mass, a thickness of 2 mm and a diameter of 65 mm was subjected to the fabric polishing and the electrolytic polishing, and this was used as the aluminum substrate.

A 0.3 M aqueous solution of oxalic acid was adjusted to be at 15° C., and the aluminum substrate was immersed in this, and a current was allowed to flow intermittently to the aluminum substrate by repeating the power ON/OFF of the direct current stabilizer so as to conduct the anodization. The operation to apply a constant voltage of 80 V for 5 seconds for every 30 seconds was repeated 60 times. This allowed an oxide film having pores to be formed on the aluminum substrate (process (a)).

Subsequently, the aluminum substrate on which an oxide film was formed was immersed in an aqueous solution obtained by mixing phosphoric acid of 6% by mass and chromic acid of 1.8% by mass at 70° C. for 6 hours. This allowed the oxide film to be dissolved and removed (process (b)).

The aluminum substrate from which the oxide film was dissolved and removed was immersed in a 0.05 M aqueous solution of oxalic acid adjusted at 16° C. and subjected to the anodization at 80 V for 7 seconds (process (c)).

Subsequently, the aluminum substrate was immersed in a 5% by mass aqueous solution of phosphoric acid adjusted at 32° C. for 20 minutes so as to conduct the pore size expanding treatment to expand the pores of the oxide film (process (d)). The anodization and the pore size expanding treatment were conducted 5 times in total for each by alternately repeating them (processes (e) and (f)), thereby obtaining a mold in which anodized alumina having substantially conical-shaped pores with an average interval of 180 nm and an average depth of 180 nm was formed on the surface.

The mold thus obtained was immersed in a mold releasing agent (0.1% by mass aqueous solution of “TDP-8” manufactured by Nikko Chemicals Co., Ltd.) for 10 minutes and the mold was then withdrawn therefrom and air-dried for the night, thereby obtaining the mold B that was release-treated.

“Preparation of Active Energy Ray-Curable Resin Composition”

(Preparation of Active Energy Ray-Curable Resin Composition A)

The active energy ray-curable resin composition A (resin composition A) was prepared by mixing 20 parts by mass of dipentaerythritol hexaacrylate (“DPHA” manufactured by Nippon Kayaku Co., Ltd.), 20 parts by mass of pentacrythritol triacrylate (“New Frontier PET-3” manufactured by DAI-ICHI KOGYO SEIYAKU CO., LTD.), 35 parts by mass of polyethylene glycol diacrylate (“A-200” manufactured by SHIN-NAKAMURA CHEMICAL CO., LTD.) and 25 parts by mass of N,N-dimethylacrylamide (“DMAA” manufactured by Kohjin co., Ltd.) as the polymerizable components, 1.0 part by mass of 1-hydroxycyclohexyl phenyl ketone (“IRGACURE184” manufactured by BASF) and 0.5 part by mass of bis(2,4,6-trimethylbenzoyl)-phenylphosphine oxide (“IRGACURE819” manufactured by BASF) as the polymerization initiators and 0.1 part by mass of a mold releasing agent (“MOLD WIZ INT-1856” manufactured by TOMOE Engineering Co., Ltd.).

(Preparation of Active Energy Ray-Curable Resin Composition B)

The active energy ray-curable resin composition B (resin composition B) was prepared by mixing 50 parts by mass of polyethylene glycol diacrylate (“M-260” manufactured by TOAGOSEI CO., LTD.) and 50 parts by mass of EO-modified compound of dipentaerythritol hexaacrylate (“DPEA-12” manufactured by Nippon Kayaku Co., Ltd.) as the polymerizable components, 1.0 part by mass of 1-hydroxycyclohexyl phenyl ketone (“IRGACURE184” manufactured by BASF) and 0.5 part by mass of bis(2,4,6-trimethylbcnzoyl)-phenylphosphine oxide (“IRGACURE819” manufactured by BASF) as the polymerization initiators and 0.1 part by mass of a mold releasing agent (“MOLD WIZ INT-1856” manufactured by TOMOE Engineering Co., Ltd.).

(Preparation of Active Energy Ray-Curable Resin Composition C)

The active energy ray-curable resin composition C (resin composition C) was prepared by mixing 22 parts by mass of dipentaerythritol hexaacrylate (“DPHA” manufactured by Nippon Kayaku Co., Ltd.) and 78 parts by mass of ethoxylated pentaerythritol tetraacrylate (“ATM-35E” manufactured by SHIN-NAKAMURA CHEMICAL CO., LTD.) as the polymerizable components, 1.0 part by mass of 1-hydroxycyclohexyl phenyl ketone (“IRGACURE184” manufactured by BASF) and 0.5 part by mass of bis(2,4,6-trimethylbenzoyl)-phcnylphosphine oxide (“IRGACURE819” manufactured by BASF) as the polymerization initiators and 0.1 part by mass of a mold releasing agent (“MOLD WIZ INT-1856” manufactured by TOMOE Engineering Co., Ltd.).

(Preparation of Active Energy Ray-Curable Resin Composition D)

The active energy ray-curable resin composition D (resin composition D) was prepared by mixing 25 parts by mass of dipentaerythritol hexaacrylate (“DPHA” manufactured by Nippon Kayaku Co., Ltd.), 25 parts by mass of pentaerythritol triacrylate (“New Frontier PET-3” manufactured by DAI-ICHI KOGYO SEIYAKU CO., LTD.), 25 parts by mass of polyethylene glycol diacrylate (“M-260” manufactured by TOAGOSEI CO., LTD.) and 25 parts by mass of EO-modified compound of dipentaerythritol hexaacrylate (“DPEA-12” manufactured by Nippon Kayaku Co., Ltd.) as the polymerizable components, 1.0 part by mass of 1-hydroxycyclohexyl phenyl ketone (“IRGACURE184” manufactured by BASF) and 0.5 part by mass of bis(2,4,6-trimethylbenzoyl)-phenylphosphine oxide (“IRGACURE819” manufactured by BASF) as the polymerization initiators and 0.1 part by mass of a mold releasing agent (“MOLD WZ INT-1856” manufactured by TOMOE Engineering Co., Ltd.).

(Preparation of Active Energy Ray-Curable Resin Composition E)

The active energy ray-curable resin composition E (resin composition E) was prepared by mixing 50 parts by mass of a polyfunctional urethane acrylate (“New Frontier R-1150D” manufactured by DAI-ICHI KOGYO SEIYAKU CO., LTD.), 10 parts by mass of caprolactone-modified dipentaerythritol hexaacrylate (“DPCA-30” manufactured by Nippon Kayaku Co., Ltd.) and 40 parts by mass of 1,6-hexanediol diacrylate (“Viscoat #230” manufactured by OSAKA ORGANIC CHEMICAL INDUSTRY LTD.) as the polymerizable components, 3.0 parts by mass of 1-hydroxycyclohexyl phenyl ketone (“IRGACURE184” manufactured by BASF) and 1.0 part by mass of bis(2,4,6-trimethylbenzoyl)-phenylphosphine oxide (“IRGACURE819” manufactured by BASF) as the polymerization initiators and 0.1 part by mass of a mold releasing agent (“MOLD WIZ INT-1856” manufactured by TOMOE Engineering Co., Ltd.).

### Example 1

### Process 1

### Formation of Intermediate Layer

Few drops of the resin composition A was dropped on the surface of the mold A. The resin composition A was covered with a triacetyl cellulose film having a thickness of 80 μm as the substrate (“TD80ULM” manufactured by FUJIFILM Corporation, hereinafter also referred to as the “TAC film”) while spreading out the resin composition A with the TAC film. Thereafter, the resin composition A was cured by irradiating with ultraviolet light from the TAC film side at the energy of 1000 mJ/cm² using a high pressure mercury lamp. The cured product of the resin composition A was released from the mold A together with the TAC film, thereby obtaining a laminate film in which an intermediate layer that had a fine relief structure with an average interval between the adjacent convex portions of 100 nm and an average height of the convex portions of 180 nm (aspect ratio: 1.8) on the surface and a film thickness of 3 μm was laminated on a substrate.

### Process 2

### Formation of Outermost Layer

Few drops of the resin composition B was dropped on the surface of the mold B. The resin composition B was covered with the laminate film obtained above while spreading out the resin composition B with the laminate film. Thereafter, the resin composition B was cured by irradiating with ultraviolet light from the laminate film side at the energy of 1000 mJ/cm² using a high pressure mercury lamp. The cured product of the resin composition B was released from the mold together with the laminate film, thereby obtaining a film-shaped laminate structure in which an outermost layer that had a fine relief structure with an average interval between the adjacent convex portions of 180 nm and an average height of the convex portions of 180 nm (aspect ratio: 1.0) on the surface and a film thickness of 8 pim was laminated on the intermediate layer of the laminate film. Meanwhile, the fine relief structures formed on the surfaces of the intermediate layer and the outermost layer had different dispositions.

The elastic modulus and elastic recovery rate of the cured product of the resin composition used in the process 2 were measured, and these were adopted as the elastic modulus and elastic recovery rate of the outermost layer. The results are presented in Table 1.

For the laminate structure thus obtained, the adhesion and the excoriation resistance were evaluated and the reflectance, the haze, and the blocking resistance were measured. The results are presented in Table 2.

### Example 2

A laminate structure was manufactured in the same manner as in Example 1 except that the TAC film was changed to an acrylic film (“ACRYPLEN” manufactured by Mitsubishi Rayon Co., Ltd., thickness: 100 μm) in the process 1 and the resin composition B was changed to the resin composition C in the process 2, and subjected to the various kinds of measurements and evaluations. The results are presented in Tables 1 and 2.

Meanwhile, the average intervals between the adjacent convex portions, the average heights of the convex portions and the aspect ratios of the fine relief structures formed on the surfaces of the intermediate layer and the outermost layer were the same as those in Example 1, and the fine relief structures formed on the surfaces of the intermediate layer and the outermost layer had different dispositions.

### Example 3

A laminate structure was manufactured in the same manner as in Example 1 except that the mold B was changed to the mold A and the resin composition B was changed to the resin composition D in the process 2, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the intermediate layer were the same as those in Example 1, the average interval between the adjacent convex portions, the average height of the convex portions and the aspect ratio of the fine relief structure formed on the surface of the outermost layer were 100 nm, 180 nm and 1.8, respectively. In addition, the fine relief structures formed on the surfaces of the intermediate layer and the outermost layer had different dispositions.

### Example 4

A laminate structure was manufactured in the same manner as in Example 1 except that the TAC film was changed to the acrylic film and the resin composition A was changed to the resin composition E in the process 1, and subjected to the various kinds of measurements and evaluations. The results are presented in Tables 1 and 2.

Meanwhile, the average intervals between the adjacent convex portions, the average heights of the convex portions and the aspect ratios of the fine relief structures formed on the surfaces of the intermediate layer and the outermost layer were the same as those in Example 1, and the fine relief structures formed on the surfaces of the intermediate layer and the outermost layer had different dispositions.

### Example 5

A laminate structure was manufactured in the same manner as in Example 1 except that the TAC film was changed to the acrylic film and the resin composition A was changed to the resin composition E in the process 1 and the resin composition B was changed to the resin composition C in the process 2, and subjected to the various kinds of measurements and evaluations. The results are presented in Tables 1 and 2.

Meanwhile, the average intervals between the adjacent convex portions, the average heights of the convex portions and the aspect ratios of the fine relief structures formed on the surfaces of the intermediate layer and the outermost layer were the same as those in Example 1, and the fine relief structures formed on the surfaces of the intermediate layer and the outermost layer had different dispositions.

### Comparative Example 1

A laminate structure was manufactured in the same manner as in Example 1 except that the mold A was changed to an aluminum substrate which did not have a reverse structure of a fine relief structure formed on the surface and had a mirror finished surface (hereinafter, simply referred to as the “mirror aluminum substrate”) in the process 1, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were the same as those in Example 1.

### Comparative Example 2

A laminate structure was manufactured in the same manner as in Example 1 except that the mold A was changed to the mirror aluminum substrate and the TAC film was changed to the acrylic film in the process 1 and the resin composition B was changed to the resin composition C in the process 2, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were the same as those in Example 1.

### Comparative Example 3

A laminate structure was manufactured in the same manner as in Example 1 except that the mold A was changed to the mirror aluminum substrate in the process 1 and the mold B was changed to the mold A and the resin composition B was changed to the resin composition D in the process 2, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were 100 nm, 180 nm and 1.8, respectively.

### Comparative Example 4

A laminate structure was manufactured in the same manner as in Example 1 except that the mold A was changed to the mirror aluminum substrate, the TAC film was changed to the acrylic film and the resin composition A was changed to the resin composition E in the process 1, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were the same as those in Example 1.

### Comparative Example 5

A laminate structure was manufactured in the same manner as in Example 1 except that the mold A was changed to the mirror aluminum substrate, the TAC film was changed to the acrylic film and the resin composition A was changed to the resin composition E in the process 1 and the resin composition B was changed to the resin composition C in the process 2, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were the same as those in Example 1.

### Reference Example 1

Few drops of the resin composition A was dropped on the surface of the mold A. The resin composition A was covered with the TAC film while spreading out the resin composition A with the TAC film. Thereafter, the resin composition A was cured by irradiating with ultraviolet light from the TAC film side at the energy of 1000 mJ/cm² using a high pressure mercury lamp. The cured product of the resin composition A was released from the mold A together with the TAC film, thereby obtaining a film-shaped laminate structure in which an outermost layer that had a fine relief structure with an average interval between the adjacent convex portions of 100 nm and an average height of the convex portions of 180 nm (aspect ratio: 1.8) on the surface and a film thickness of 3 μm was laminated on a substrate.

The laminate structure thus obtained was subjected to the various kinds of measurements and evaluations. The results are presented in Tables 1 and 2.

### Reference Example 2

A laminate structure was manufactured in the same manner as in Reference Example 1 except that the TAC film was changed to the acrylic film, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were the same as those in Reference Example 1.

### Reference Example 3

A laminate structure was manufactured in the same manner as in Reference Example 1 except that the mold A was changed to the mold B and the resin composition A was changed to the resin composition B, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were 180 nm, 180 nm and 1.0, respectively.

### Reference Example 4

A laminate structure was manufactured in the same manner as in Reference Example 1 except that the TAC film was changed to the acrylic film, the mold A was changed to the mold B and the resin composition A was changed to the resin composition C, and subjected to the various kinds of measurements and evaluations. The results are presented in Tables 1 and 2.

Meanwhile, the average interval between the adjacent convex portions, the average height of the convex portions and the aspect ratio of the fine relief structure formed on the surface of the outermost layer were 180 nm, 180 nm and 1.0, respectively.

TABLE 1

| | | Intermediate layer | | | Outermost layer | | | | |
|---|---|---|---|---|---|---|---|---|---|
| | | | | Film | | | Film | Elastic | Elastic |
| | | | Resin | thickness | | Resin | thickness | modulus | recovery rate |
| | Substrate | Mold | composition | [μm] | Mold | composition | [μm] | [MPa] | [%] |
| Example 1 | TAC | A | A | 3 | B | B | 8 | 252 | 94 |
| Example 2 | Acrylic | A | A | 3 | B | C | 15 | 287 | 94 |
| Example 3 | TAC | A | A | 3 | A | D | 10 | 2034 | 73 |
| Example 4 | Acrylic | A | E | 8 | B | B | 15 | 252 | 94 |
| Example 5 | Acrylic | A | | 8 | B | C | 8 | 287 | 94 |
| Comparative | TAC | Mirror | A | 3 | B | B | 8 | 252 | 94 |
| Example 1 | | | | | | | | | |
| Comparative | Acrylic | Mirror | A | 3 | B | C | 15 | 287 | 94 |
| Example 2 | | | | | | | | | |
| Comparative | TAC | Mirror | A | 3 | A | D | 10 | 2034 | 73 |
| Example 3 | | | | | | | | | |
| Comparative | Acrylic | Mirror | E | 8 | B | B | 15 | 252 | 94 |
| Example 4 | | | | | | | | | |
| Comparative | Acrylic | Mirror | E | 8 | B | C | 8 | 287 | 94 |
| Example 5 | | | | | | | | | |
| Reference | TAC | — | — | — | A | A | 3 | 3141 | 54 |
| Example 1 | | | | | | | | | |
| Reference | Acrylic | — | — | — | A | A | 3 | 3141 | 54 |
| Example 2 | | | | | | | | | |
| Reference | TAC | — | — | — | B | B | 8 | 252 | 94 |
| Example 3 | | | | | | | | | |
| Reference | Acrylic | — | — | — | B | C | 15 | 287 | 94 |
| Example 4 | | | | | | | | | |

TABLE 2

| | Evaluation | | | | |
|---|---|---|---|---|---|
| | | | Antireflection property | | |
| | | Excoriation | Luminosity factor | Transparency | Blocking |
| | Adhesion | resistance | reflectance [%] | Haze [%] | resistance |
| Example 1 | ◯ | ⊙ | 0.1 | 0.6 | ◯ |
| Example 2 | ◯ | ⊙ | 0.1 | 0.7 | ◯ |
| Example 3 | ◯ | Δ | 0.1 | 0.6 | ◯ |
| Example 4 | ◯ | ⊙ | 0.1 | 0.6 | ◯ |
| Example 5 | ◯ | ⊙ | 0.1 | 0.6 | ◯ |
| Comparative Example 1 | X | X* | 0.1 | 0.6 | ◯ |
| Comparative Example 2 | X | X* | 0.1 | 0.7 | ◯ |
| Comparative Example 3 | X | X* | 0.1 | 0.7 | ◯ |
| Comparative Example 4 | X | X* | 0.1 | 0.6 | ◯ |
| Comparative Example 5 | X | X* | 0.1 | 0.6 | ◯ |
| Reference Example 1 | ◯ | X | 0.1 | 0.6 | — |
| Reference Example 2 | ◯ | X | 0.1 | 0.5 | — |
| Reference Example 3 | X | X* | 0.1 | 0.6 | — |
| Reference Example 4 | X | ⊙ | 0.1 | 0.7 | — |

Incidentally, in Table 1, the “TAC” represents the TAC film, the “acrylic” represents the acrylic film, and the “mirror” represents the mirror aluminum substrate.

As can be seen from the results of Tables 1 and 2, the laminate structures of Examples 1 to 5 which had fine relief structures differently disposed on the surfaces of the intermediate layer and the outermost layer exhibited favorable adhesion, excoriation resistance, antireflection property and transparency. In addition, they were also excellent in blocking resistance.

On the other hand, the laminate structures of Comparative Examples 1 to 5 in which a fine relief structure was not formed on the surface of the intermediate layer exhibited antireflection property and transparency comparable to the laminate structure of each Example but were poor in adhesion between the intermediate layer and the outermost layer, and the outermost layer peeled off at the time of conducting the wear test to evaluate the excoriation resistance.

In addition, as can be seen from Reference Examples 1 and 2, the resin composition A excellent in adhesion to the substrate was poor in excoriation resistance, and as can be seen from Reference Example 4, the resin composition C excellent in excoriation resistance was poor in adhesion to the substrate.

From these results, it has been indicated that it is possible to achieve both adhesion and excoriation resistance as two or more layers have specific fine relief structures on the surfaces according to the invention.

### INDUSTRIAL APPLICABILITY

The laminate structure of the invention is useful as an optical article, particularly an antireflective article such as an antireflective film which exhibits high adhesion between the layers and excellent optical performance and mechanical properties.

### EXPLANATIONS OF LETTERS OR NUMERALS

10, 50, 60, 70, 80, 90 and 100 laminate structure
10′ laminate
12 substrate
14 intermediate layer
14a layer which has a fine relief structure on the surface
14b layer which does not have a fine relief structure on the surface
16 outermost layer
20 aluminum substrate
22 pore
24 oxide film
26 pore generating point
28 mold
30 roll-shaped mold
32 tank
34 pneumatic cylinder
36 nip roll
38 active energy ray irradiating device
40 peeling roll

1. A laminate structure comprising two or more layers laminated, wherein
at least two layers have a fine relief structure on surfaces thereof,
a concave portion and a convex portion of a fine relief structure of an arbitrary layer are differently disposed from a concave portion and a convex portion of a fine relief structure of another at least one layer, and
an interface is not release treated.

2. The laminate structure according to claim 1, wherein an average interval between concave portions or convex portions of a fine relief structure of an arbitrary layer is different from an average interval between concave portions or convex portions of a fine relief structure of another at least one layer.

3. The laminate structure according to claim 1, wherein at least an outermost layer has a fine relief structure on a surface thereof.

4. The laminate structure according to claim 3, wherein an average interval between concave portions or convex portions of a fine relief structure of an outermost layer is greater than an average interval between concave portions or convex portions of a fine relief structure of another at least one layer.

5.-17. (canceled)

18. The laminate structure according to claim 1, wherein an outermost layer is a coating layer which does not have a fine relief structure on a surface thereof.

19. The laminate structure according to claim 1, wherein an elastic recover rate of an outermost layer is 70% or more.

20. The laminate structure according to claim 1, wherein an elastic modulus of an outermost layer is 80 MPa or more.

21. The laminate structure according to claim 1, wherein the layer having a fine relief structure on a surface thereof is a layer including a cured product of an active energy ray-curable resin composition.

22. The laminate structure according to claim 1, wherein the active energy ray-curable resin composition contains a (meth)acrylate.

23. The laminate structure according to claim 1, wherein the number of notches that are peeled off when 100 squares of grid-shaped notches are formed at an interval of 2.0 mm and a pressure sensitive adhesive tape is pasted to these notches and then peeled off therefrom is less than 50 squares among the 100 squares in the cross-cut tape peeling test performed in conformity with JIS K 5600-5-6: 1999 (ISO 2409: 1992).

24. An article comprising the laminate structure according to claim 1 on a surface thereof.

25. A laminate structure comprising two or more layers laminated, wherein
an outermost layer is a layer which does not have a fine relief structure on a surface thereof, and
at least one layer other than the outermost layer has a fine relief structure on a surface thereof.

26. The laminate structure according to claim 25, wherein an outermost layer is a coating layer which does not have a fine relief structure on a surface thereof.

27. The laminate structure according to claim 25, wherein an elastic recovery rate of an outermost layer is 70% or more.

28. The laminate structure according to claim 25, wherein an elastic modulus of an outermost layer is 80 MPa or more.

29. The laminate structure according to claim 25, wherein the layer having a fine relief structure on a surface thereof is a layer including a cured product of an active energy ray-curable resin composition.

30. The laminate structure according to claim 29, wherein the active energy ray-curable resin composition contains a (meth)acrylate.

31. The laminate structure according to claim 25, wherein the number of notches that are peeled off when 100 squares of grid-shaped notches are formed at an interval of 2.0 mm and a pressure sensitive adhesive tape is pasted to these notches and then peeled off therefrom is less than 50 squares among the 100 squares in the cross-cut tape peeling test performed in conformity with JIS K 5600-5-6: 1999 (ISO 2409: 1992).

32. An article comprising the laminate structure according to claim 25 on a surface thereof.

33. A method for manufacturing the laminate structure according to claim 1, the method comprising the following processes (1-1) and (1-2):
(1-1) a process of supplying an active energy ray-curable resin composition for an intermediate layer on a substrate, transferring a fine relief structure using a mold having a fine relief structure on a surface thereof, subsequently curing the active energy ray-curable resin composition for an intermediate layer to which the fine relief structure is transferred by irradiating with an active energy ray to form an intermediate layer, and then peeling off the intermediate layer from the mold; and
(1-2) a process of supplying an active energy ray-curable resin composition for an outermost layer on a surface of the intermediate layer obtained after repeating the process (1-1) one or more times, transferring a fine relief structure using a mold having a fine relief structure on a surface thereof, subsequently curing the active energy ray-curable resin composition for an outermost layer to which the fine relief structure is transferred by irradiating with an active energy ray to form an outermost layer, and then peeling off the outermost layer from the mold.

34. A method for manufacturing the laminate structure according to claim 1, the method comprising the following processes (2-1) and (2-2):
(2-1) a process of supplying an active energy ray-curable resin composition for an outermost layer on a surface of a mold having a fine relief structure on the surface and transferring the fine relief structure of the mold; and
(2-2) a process of disposing a substrate on which an intermediate layer having a fine relief structure on a surface thereof is laminated on the active energy ray-curable resin composition for an outermost layer on the mold such that an intermediate layer side is in contact therewith, subsequently curing the active energy ray-curable resin composition for an outermost layer to which the fine relief structure is transferred by irradiating with an active energy ray to form an outermost layer, and then peeling off the outermost layer from the mold.

35. A method for manufacturing the laminate structure according to claim 1, the method comprising the following processes (3-1) and (3-2):
(3-1) a process of supplying an active energy ray-curable resin composition for an outermost layer on a surface of a mold having a fine relief structure on the surface, transferring the fine relief structure of the mold, and subsequently semi-curing the active energy ray-curable resin composition for an outermost layer to which the fine relief structure is transferred by irradiating with an active energy ray; and
(3-2) a process of disposing a substrate on which an intermediate layer having a fine relief structure on a surface thereof is laminated on the semi-cured active energy ray-curable resin composition for an outermost layer on the mold such that an intermediate layer side is in contact therewith, subsequently curing the semi-cured active energy ray-curable resin composition for an outermost layer by irradiating with an active energy ray to form an outermost layer, and then peeling off the outermost layer from the mold.

36. A method for manufacturing the laminate structure according to claim 25, the method comprising the following processes (4-1) and (4-2):
(4-1) a process of supplying an active energy ray-curable resin composition for an intermediate layer on a substrate, transferring a fine relief structure using a mold having a fine relief structure on a surface thereof, subsequently curing the active energy ray-curable resin composition for an intermediate layer to which the fine relief structure is transferred by irradiating with an active energy ray to form an intermediate layer, and then peeling off the intermediate layer from the mold; and
(4-2) a process of forming an outermost layer on a surface of the intermediate layer obtained after repeating the process (4-1) one or more times.
